(19) United States
(12) Patent Application Publication
(10) Pub. No.: US 2025/0390759 A1
(43) Pub. Date: Dec. 25, 2025

(54) DISTRIBUTED NEURAL NETWORK HAVING MULTIPLE INJECTION POINTS SUPPORTING AUTOMATIC THEATER PRODUCTION

(71) Applicant: Fantagic Holdings LLC, Naples, FL (US)

(72) Inventors: James Duane Bennett, Naples, FL (US); Bindu Rama Rao, Naples, FL (US)

(21) Appl. No.: 19/242,513

(22) Filed: Jun. 18, 2025

Related U.S. Application Data
(60) Provisional application No. 63/661,708, filed on Jun. 19, 2024.

(51) Int. Cl. G06N 3/10

(52) U.S. Cl. CPC G06N 3/10

(57) ABSTRACT

An artificial intelligence infrastructure comprises a first circuitry configured to offer multiple injection points. The circuitry is configured to automatically distribute neural network processing across a local computing device and at least one remote computing device while receiving and processing influence data at the multiple injection points. Furthermore, the first circuitry is configured to inject influences at a plurality of injection points to serve an overall objective. The circuitry is also configured to automatically distribute neural network nodes across one local user's computing device and at least one remote host computing device to accomplish, using artificial intelligence, the overall objective.

### RELATED APPLICATIONS

The present application incorporates by reference herein in its entirety and for all purposes U.S. Provisional Applications: a) Ser. No. 63/525,817, filed Jul. 10, 2023, entitled “Multi-Node Influence Based Artificial Intelligence Topology” (EFS ID: 48272269; Atty. Docket No. GA01); b) Ser. No. 63/528,145, filed Jul. 21, 2023, entitled “Segment Sequencing Artificial Intelligence Topology” (EFS ID: 48330922; Atty. Docket No. GA02); c) Ser. No. 63/529,461, filed Jul. 28, 2023, entitled “Artificial Intelligence Store with Builder and Client Side Personalized Trusted Output” (EFS ID: 48365256; Atty. Docket No. GA03); and d) Ser. No. 63/534,540, filed Aug. 24, 2023, entitled “Automated Artificial Intelligence Topology Generation” (EFS ID: 48489367, Atty. Docket No. GAI04).

### BACKGROUND

### 1. Technical Field

The present invention relates generally to generative and discriminative artificial intelligence; and, more particularly, to remote and local artificial intelligence serving a common functional objective.

### 2. Related Art

Basic training and deployment of single nodes of generative and discriminative Artificial Intelligence (hereinafter “AI”) is commonplace. Various AI models currently exist while other models are under development to gain high quality AI output and discrimination. In addition to the model's themselves, the amount of training data utilized continues to grow with quality of training data also becoming more important.

AI models are designed and trained to operate as single node AI elements, for example, taking in user text queries and output anything such as a poem, short story, or summary description. This comprises only a fraction of what each user might like to accomplish in their particular overall goal underlying their desire to use the single node AI service. To have custom designs prepared for a user, high costs and skill levels are required. As is, only the largest of companies are integrating AI solutions using teams of AI experts.

These and other limitations and deficiencies associated with the related art may be more fully appreciated by those skilled in the art after comparing such related art with various aspects of the present invention as set forth herein with reference to the figures.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a schematic diagram illustrating an exemplary generation of a user's content, by an artificial intelligence (herein, “AI”) based generating infrastructure, wherein multiple types of influence data are to be injected at various points to service the overall repeated object with and without user involvement, wherein the output generation is controlled by these influence data;

FIG. 2 is a schematic diagram illustrating an exemplary generation of a user's content, by an artificial intelligence based generating infrastructure, wherein multiple types of influence data are used to train a query training subset, a pattern training subset, a cross-node training subset and a control training subset, such that each of these subsets subsequently provide corresponding necessary influences to a AI Node responsible for output generation processing;

FIG. 3 is a schematic diagram illustrating an exemplary generation, by an artificial intelligence (herein, “AI”) based generating infrastructure, wherein AI generation makes use of multiple types of influence data namely pattern, cross node and query that are provided to a decoder;

FIG. 4 is a schematic diagram illustrating the use of two different injection points as part of a AI generation activity where inputs and influences are provided in text form;

FIG. 5 is a schematic diagram illustrating an exemplary generation of a story book, by an artificial intelligence (herein, “AI”) based generating infrastructure, wherein a user query is received which is used to search a private data to generate a user's private data embellished query;

FIG. 6 is a schematic diagram illustrating an exemplary AI based generation environment that uses various kinds of user systems that interact with various kinds of creator systems, wherein the environment also provides for a AI store service for storage and access control, and a neural network, core processing & accelerator host circuitry for AI based generation functionality;

FIG. 7 is a schematic diagram illustrating an exemplary encoder portion where injection functionality provides for flexible injection of influences into remote circuitry or to local private circuitry;

FIG. 8 is a schematic diagram illustrating an exemplary encoder portion wherein injection of influences are split between the hosting circuitry and the user device. For example a low power user device would conduct embedding and positional encoding locally, using a private data embellished query as necessary;

FIG. 9 is an exemplary flow diagram that illustrates a process for generating a plurality of topology frames based on user source data and prior user created output data, wherein the process delivers an auto-generated set of topologies to serve future overall generative goals; and

FIG. 10 is a schematic diagram illustrating an exemplary encoder portion wherein a neural network is split between the hosting circuitry 1003 and the user device 1001. As necessary, injection of influences is also split between the hosting circuitry 1003 and the user device 1001.

FIG. 11 is a schematic diagram of a content generating and theater play infrastructure that comprises a theatre player used to experience animations and other digital content in a theatre like setting, a testbench where a content creator can test the quality and appropriateness of a created content prior to its curation or sharing, a builder output & asset dB that is used to store assets and curated outputs, a builder based 3^{rd} party ad service, a rehearsal app that is used to optionally enhance or modify a content and play it to check its performance, and a builder based internal ad service.

FIG. 12 depicts an integrated system architecture involving various components interconnected through the Internet, with interactions on the backend with the build output & asset dB.

FIG. 13 depicts an interconnected system architecture involving various components essential for developing, managing, and editing digital content, such as a testbench and a rehearsal app.

FIG. 14 depicts exemplary interactions between a UI & API wrap & Coax service and a builder output & asset dB, which results in triggering activities in the social builder output sharing & derivative work platform.

FIG. 15 depicts an exemplary user interaction window of the ESP Editor of FIG. 11 wherein an ESP Coaxing & Wrapper setup window facilitates specification or modification of a subject such as a skeleton of a storyline or a brief description of a required output, a cast(s) of actors, an appearance information provided as description of the actors, emotional states of the actors, a target age for consumers of the generated output, the type of output such as a theatre play, and the length of the output in lines and acts.

FIG. 16 is a functional block diagram of a further embodiment of the present invention wherein a theater performance is produced in an automatic approach with opportunities for editing.

### DETAILED DESCRIPTION OF THE DRAWINGS

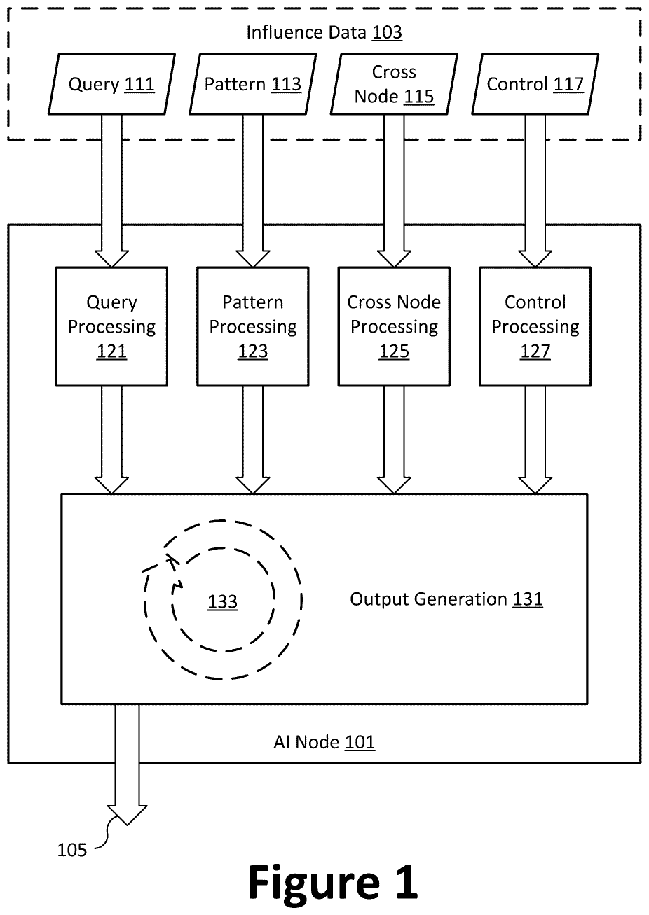

FIG. 1 is a schematic diagram illustrating an exemplary generation of a user's content, by an artificial intelligence (herein, “AI”) based generating infrastructure, wherein multiple types of influence data 103 are to be injected at various points to service the overall repeated object with and without user involvement, wherein the output generation is controlled by these influence data 103. Although many other types of influence data is contemplated, in the present embodiment, the influence data 103 comprises query influence 111, pattern influence 113, cross node influence 115 and control 117. Depending how these influences are input, these influences may be in the form of text in a language such as English, in the form of words associated with a button on a user screen or in the form of electronic signals of some type received from a device.

The query influence 111, the pattern influence 113, the cross-node influence 115 and the control 117 are correspondingly processed by a query processing module 121, a pattern processing module 123, a cross-node processing module 125 and a control processing module 127 of an AI Node 101. The modules 121-127 translate text tags into formats that can be injected into an output generation 131. In some embodiments, the different types of the influence data 103 are converted from text tags to vectors, and then pre-processed before use in influencing the output generation 131. Although all of the types of the influence data 103 may be pre-processed identically, they may also be preprocessed quite differently. For example, grammatical text of the query 111 might be processed to remove words of little importance and to deliver emphasis to word pairs that together bring deliver more meaning, while a command tagged structure, the control 117, might completely ignore such preprocessing as it might be conveyed in an expected tag structured arrangement. In addition, the query 111 may hold much higher importance than data that originates from the cross node 115. Because of this, the cross node processing 125 can be configured to lower the impact of the cross node data, the cross node 115, while raising the relative impact or influence of the query data (i.e., the query 111) on the output generation 131.

Thus, depending on the embodiment, the output generation 131 receives influence from the influence data 103 with different pre-processing and weighting, thus allowing the output generation 131 to deliver more accurately tailored output that if all influence data 103 had been combined into a single input pathway into the output generation 131. In addition, although only a certain set of distinct types of influence data 103 is show, many other types are contemplated.

The AI Node 101 may have particular features that distinguish the output generation 131 from the query processing 121, pattern processing 123, cross node processing 125 and control processing 127. In a transformer model, for example, the output generation 131 might comprise a decoder element that generates text output in a word by word manner, as illustrated by the cyclic symbol 133. To complete the transformer model, the output generation 131 from the query processing 121, pattern processing 123, cross node processing 125 and control processing 127 might comprise encoder pathways that reach to influence the decoder element.

No matter what the actual model of the AI Node 101 happens to be (which is determined by the particular embodiment), as illustrated, there are four influencing pathways and a single output, a generated output 105. The query processing 121 and query 111 define the primary pathway for user interaction and the primary source of influence on the generated output 105. Secondary sources, i.e., the pattern processing 123, cross node processing 125 and control processing 127, also deliver influence to varying degrees and some or all of which may be more influential or less influential than the primary source. Even so, hereinafter, the secondary source influence in such an arrangement are called “coaxing” influences as they coax the generated output 131 to deliver a suitable output yet still responsive to the query 111. Also, direct and independent influence delivery from the pattern processing 123, cross node processing 125 and control processing 127 each comprise “injection points” into the output generation 131.

In other embodiments, but not shown in the present FIG. 1, find mergers of different types of the influence data 103. When this is done, herein, this is referred to as providing a “wrapper” or “wrapping the query.” For example, text from the query 111 might be combined with text of the control 117, which is then delivered together to a single control pathway. This would then be a situation where the control text wrapped the query.

In the present illustration, the control 117 may comprise font size, font color and font style that will be used to influence the formatting of the generated output 105. Cross node influence 115 depends on what form the influence data emerges. If query 111 received is a sentence text, it will need attention processing to be implemented by query processing module 121. Pattern data is optionally tag based, with tags for genre, output image resolution, output color, etc. For example, a pattern can be expressed by a set of tags such as “genre: mystery; resolution: 1080p; color: BW and so on. Such a tagged pattern needs no internal attention consideration, unlike the query 111. The output generation module 131 could just be one neural network that facilitates text generation. In addition, there could be neural networks associated with modules 121-125 too. A neural network unit as used herein may comprise a single neural network or multiple neural networks arranged to perform an AI generation function.

In text generation embodiments of FIG. 1, the output generation module 131 comprises a next word predictor and, as represented by the cyclic symbol 133, the output generation 131 cycles through word by word to generate influenced text as the generated output 105.

For example, in one configuration, the query 111 is a user request such as “tell me a story about a princess”, or “tell me a story about my dog”, wherein the query 111 is unconstrained text input (or spoken to provide input in audio form) from a user, such as a child. If in a text form, the query 111 is delivered to the query processing module 121 where operations such as lower case conversion, lemmatization, vectorization, stop word analysis, weighting, stemming and other relevant operations are performed.

Similarly, the pattern 113 is, for example, a structure that the creator of the AI topology is going to predefine, or a influence information such as “mystery story for a young adult” that implies a certain genre, certain flow and certain complexity that is appropriate for a given audience/reader. Other examples of a pattern 113 are “a rhyming prose for a toddler”, “a simple poem for a pre-schooler”, etc. Thus pattern 113 is used to constrain that nature of the output generated. For example, a pattern of “story for an eight year old boy” would help determine the plot, the vocabulary, the flow and the length of the story that will be generated. Other parameters of a story may also be influenced by a pattern.

Patterns can be in sentence structure like illustrated above, but it can also be in mere tag word format or with delimiters. For example: “genra: sci-fi; age: pre-school; constraint: ryhming” or just some text tags like “mystery short-story teen” in any order. But with any ordering of tags, you don't need “attention” processing in pattern processing module 123. If the patterns have sentence form like that provided in “mystery story for a young adult”, then the pattern processing module 123 will have to do many of the same things query processing module 121 happens to conduct.

Cross-node 115 is a type of influence data that impacts partial outputs generated subsequently, such as in following pages, in following sections etc. For example, cross-node 115 is influence data wherein text on one page is used to influence an image on a subsequent page. For example, a paragraph describing a trail in a forest influences the color, appearance and orientation of an image of a child in a forest on a next page. Cross node is not only cross data types but also one paragraph on one page to the next. This also may or may not involve sentence structure processing in cross node processing module 125 depending on how the influence data originates. If the inputs to the cross node processing module 125 is the output text from one node, it will also require query processing module 111 style processing. For example, one paragraph in a current page generated describing the speech of a story's protagonist will influence, via the cross node processing module 125, the dialogues of the same protagonist in a next page.

Control 117 is influence data that impacts resolution of images, formatting style of the output generated, fonts used, color preferred, size of images generated, placement of images, length of tunes created, etc. For example, a control 117 provided for a story generation by AI Node 101 is “for all my output pages, image resolution is 1024 pixels, formatting will be within a frame of size 6 inches 4 inches, fonts should be Helvetica 13 pts., etc. Control 117 is not needed for generation of text or images in one configuration but is used in formatting of the generated output 105. However, in some configurations, control 117 is also factored in as required by the AI Node 101.

For example, a control data 117 received such as “page: A4; maxlength: 50; margins: 1 inch; font-size: 11” would be processed by control processing module 127 in a mode similar to that followed by pattern processing module 123 to process tagged inputs, as the inputs are in a similar delimited tagged format. However, if the received control data 117 is in the sentence form, then control processing would require query processing module 121 mode of processing. Thus, processing is different for control input 117 based on the format it is presented, such as plain text format or delimited tag format, etc.

The present invention with the use of the query influence 111, the pattern influence 113, the cross-node influence 115 and the control 117 makes the AI generation process “generic”, wherein the output generation 131 is now controlled or impacted by these separate inputs, with the AI Node 101 employing cyclical generative AI process, per cyclic symbol 133, until it completes.

Output generation module 131 gets biased based on the input it receives and their processing by the corresponding processing modules 121-127 in 131. For example, when the values for the processing modules 121-127 are established, the neural net comprised by the output generation module 131 will be biased in its cyclic word by word text generation operations, and as necessary, the generated output words are fed back into the output generation process in order to facilitate and influence the next word(s) and so on. Thus, the output words are also, although not shown, also fed back into output generated module 131 so that it can be further biased by its prior output to generate each next word.

It should be clear that not all processing modules 121-127 are processed the same nor do they have the same influence weighting. For example, the weight of the cross node processing module 125 might be heavier or its biasing ability is more substantial in the generation of the next word or next sentence for a given novel to be generated as output 105. And the processing modules 121-127 also can have different injection points into the overall AI node 101. That is, for example, control node 117 inputs may be only needed in the last step of output generation, and the control processing module 127 is just used to control cycling, per cyclic symbol 133, and the formatting of the output, and may not even be fed into the neural network of output generation module 131, because this input is something that can be but need not even be fed into the neural net portion of 131. Instead, it therefore influences, in whole or in part, just output formatting and cycling in accordance with the cyclic symbol 133.

In another example, query 111 is provided as a user sentence input, in textual format and therefore it requires and is given attention processing by the query processing module and the encodes associated with output generation module 131. But for patterns provided as input 113, that are delivered as patterns with only key tag words that have no ordering or relationship with each other, thereby acting as a mere series of biasing words, attention processing is not needed, and any encoder used to process it would just clone it and forward it. In addition the output of normalization of each of the processing modules 121-127 wouldn't necessarily be the same either. In some configurations, the impact “amplitude” of each set of influences 111-117 is adjusted such that a pattern does not heavily dominate the input query from the user and so on.

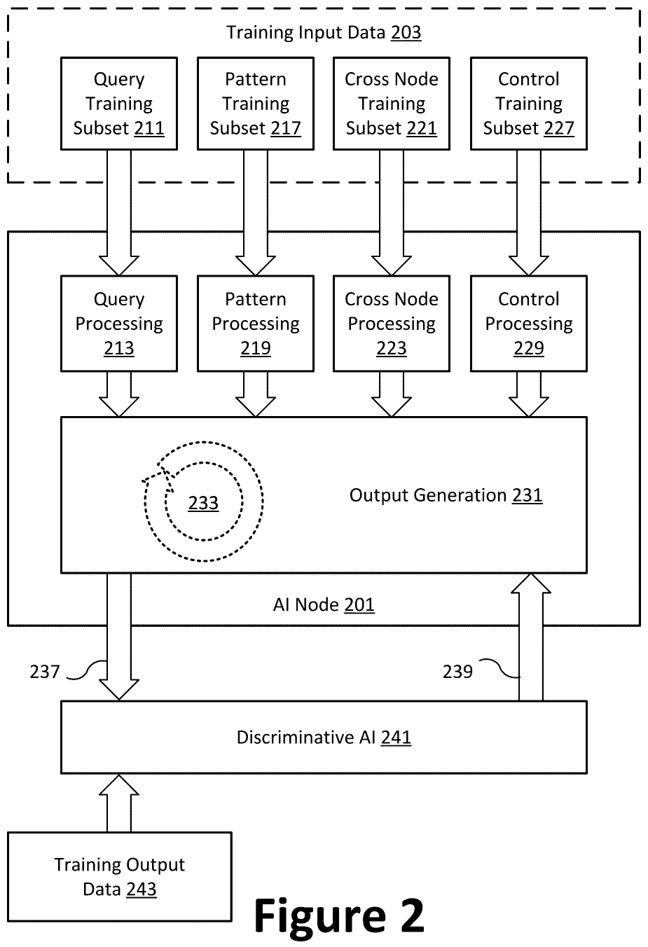

FIG. 2 is a unique training scenario wherein one of a plurality of influences 203 that are input to an artificial intelligence based generating infrastructure is varied while others of the plurality of influences are maintained at a steady level, as part of a training process. For example, given a set of different patterns for training 217, the same query and 211, cross node training data 221 and control data 227 is maintained, so that the pattern training subset 217 is stepped thru with all its variations, and corresponding output data that should be generated is stepped through too as training output data 243. Thus, one of the influences 211-227 at a time is varied while others are kept stationary during the training process and corresponding input-output pairs are used to train the output generation module 231 that comprises a neural network. All through the training process, the outputs generated 237 are compared by a discriminative AI module 241 to training output data 243 and feedback 239 is used to make changes or modifications by the output generation module 231.

For example, the variations to a stationary query 211 “give me a dog”, will have variations in the pattern data 217 such as a cartoon dog, a realistic dog, a stick figure dog, an ink fig of a dog, a dog in watercolor, etc. The outputs generated 237 are compared by the discriminative AI module 241 to training output data 243. Feedback input data 239 is provided to make the outputs 237 better and more as anticipated.

Thus, in the artificial intelligence based generating infrastructure, multiple types of influence data 203 are used to train the output generation module 231, including a query training subset 211, a pattern training subset 217, a cross-node training subset 221 and a control training subset 227, such that each of these subsets provide corresponding necessary influences to the AI Node 201 responsible for output generation processing 231. The output generation module 231 employs one or more neural networks as it cycles 233 through partial output generation operations. The AI Node 201 comprises a query processing module 213, a pattern processing module 219, a cross-node processing module 223 and a control processing module 229, to which inputs are received from query training subset 211, the pattern training subset 217, the cross-node training subset 221 and the control training subset 227, respectively. The output generation module 231 employs one or more neural networks as it cycles 233 through partial output generation prices.

In one configuration, for example, the query training subset 211 trains an AI module for query generation based on a preset pattern, a preset cross node and preset control. Thus, while holding the control training subset 227, the cross node training subset 221, and the pattern training subset 217 constant, and cycling using a variety of queries while comparing anticipated training data output 243 to generated output 237, query training is conducted. Similarly, setting up a certain query, using a certain pattern, and varying the selection across the control training subset 227, the output generation module 231 can be trained. Thus, one or more influences can be held steady or constant while training varying the remaining influence generation subsets.

Discriminative AI 241 is used for training the “one or more neural networks found within 231 wherein training output data 243 is compared to output generated 237 and if it lacks correlation, a training impact 239 is fed backward through such neural network infrastructure. The set of influences 203 is organized to cause the generation of the output 237, to which training output data 243 is compared. That is, as part of the training, one or more of influences 211, 217, 221, 227 are held at a predefined data set and then the output 237 is compared to the expected training output data 243. For example, query input 211, cross node influence 221, control training influence 227 is held while pattern 217 is modified in concert with the training output data 243. For example, if the pattern “rhyme” is to be selected in one variation for a pattern, and text for another, but all other inputs remain the same, the output 237 would “rhyme” in accordance with the pattern “rhyme”, and this would be compared to anticipated output specified by the training output data 243. Thus, in the present invention, the training process itself is quite different from traditional training approaches.

In one embodiment, a variety of anticipated output data is employed to provide a training output data 243, which is then used by a discriminative AI module 241 (other types of AI machines are also contemplated) to compare to the generated output 237 and any variation or differences between the two are fed back to the AI Node 201 as difference data 239. Thus, training output data 243 specifies what the output is supposed to be, and it is setup in the beginning such that the generated output 237 can be compared to it in order to train the AI Node 201 using the difference data 239.

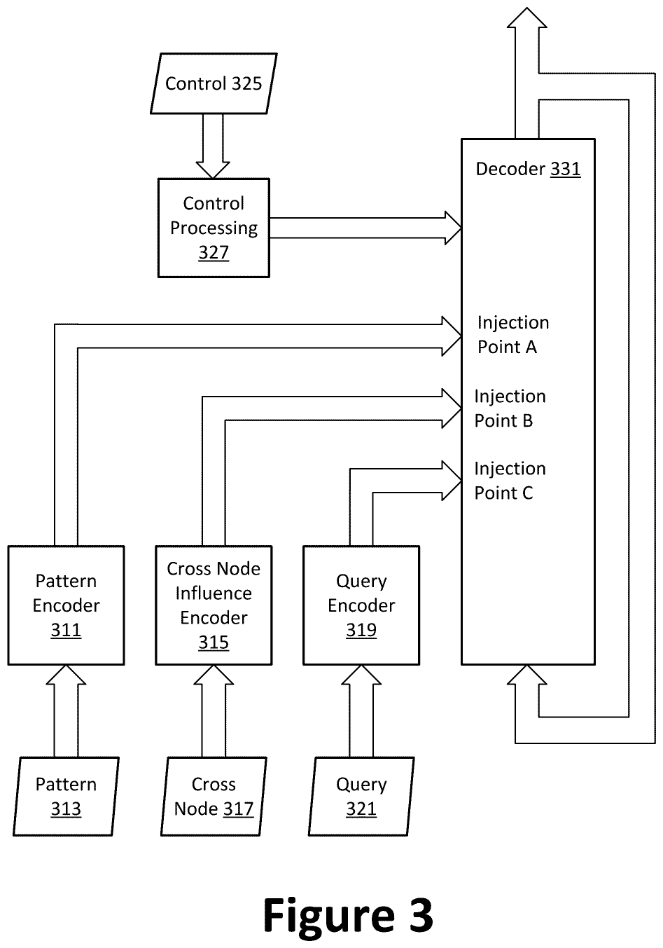

FIG. 3 is a schematic diagram illustrating an exemplary generation, by an artificial intelligence based generating infrastructure, wherein AI generation makes use of multiple types of influence data namely pattern 313, cross node 317 and query 321 that are provided to a decoder 331 at several different injection points. Specifically, in one embodiment, three corresponding injection points are employed, injection point A for pattern 313, injection point B for cross node 317 and injection point C for query 321. Thus, influence data are to be injected at various points to service the overall repeated objective with and without user involvement. The injection points in the decoder 331 also receive control data influence 325 from control processing 327 which processes control information 325 and provides it as input such that the decoder 331 factors it in output generation.

Typically, in a normal transcoder with an encoder and a decoder, the decoder has just a single common injection point. A traditional transcoder has a single encoder whose output is injected just above the cycling decoder's feedforward processing. But in accordance with the present invention, because not all injected influence data 313, 317, 321, 325 is created equal and is not always in the same format, and does not need the same kind of processing within the decoder 331 or encoder elements, there are different injection points A, B and C provided with different weighting. In the current figure, although we only show 3 types of influence, there can be any number of other types and some types can be combined, depending on the embodiment. Also, the control influence 325 is shown in the figure as not being injected at all but is being used to control the functionality (e.g., output formatting, font details, word/sentence count, etc.). The decoder 331 itself has been modified to accept all of the multiple injection points A, B and C and control flow necessary to generate the output anticipated.

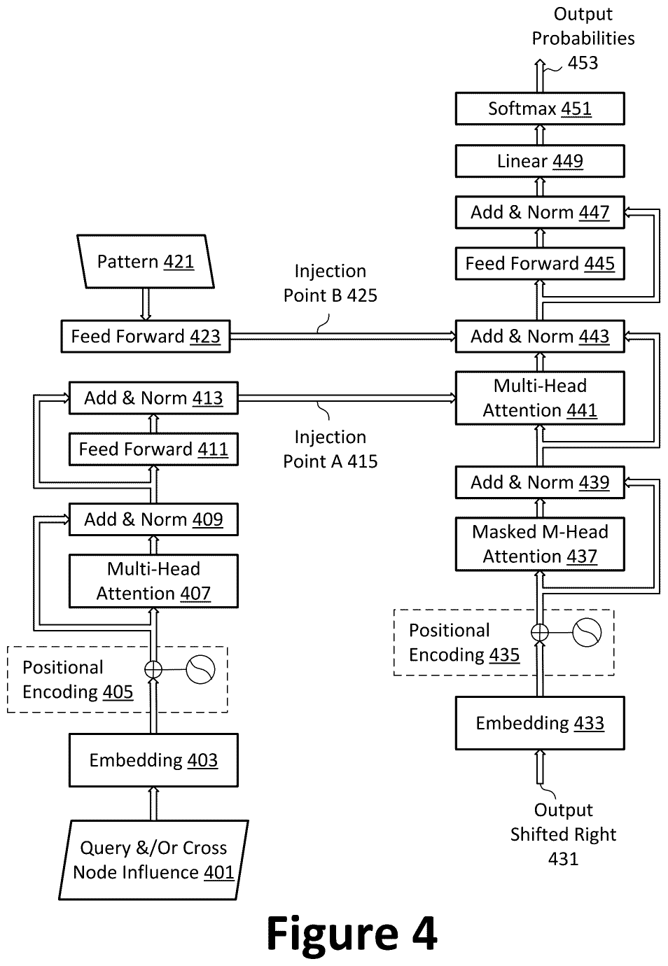

FIG. 4 is a schematic diagram illustrating an embodiment of FIG. 3 wherein an AI generation activity with inputs and influences wherein the inputs are provided in text form, and some of the influences, such as pattern influence, do not require attention processing. If the influences are determined to be stand-alone words in the form of tags, or determined to be in sentences of English grammar, they are likely to be handled differently and processed along different pathways. For example, if they are in English grammar based text (grammatically correct for example), then they will be processed through the series of blocks 403 through 413, in the traditional encoder mode. On the other hand, if the influences are standalone words provided as tags, it may not need any such processing, and the words may be actually fed by pattern block 421 to feed forward block 423 which will subsequently be forwarded through injection point B 425, which jumps ahead and avoids the multi-headed attention 441 of the decode path which is combinatorial in its processing. Thus, determining whether the multi-headed attention 441 is needed for a particular influence type such as patterns or user query is part of the design of the AI based generation embodiment of FIG. 4. Pattern influence 421 when presented as tags do not need attention processing, and that is why pattern 421 is not subjected to positional encoding 405 and multi-headed attention 407.

The pattern 421 often is likely to have been prepared by a professional or a designer (such as a professional children's storybook writer), and therefore not likely to require multi-head attention during processing, especially if it not presented as plain text but instead as tags or delimited text-value pairs. Thus the injection point B 425 is likely to be the pathway to incorporate patterns after any feed forward 423 processing that might be necessary. Such patterns, especially if an embedded pattern, are not likely to require embedding 403 either, and even feed forward 423 might be unnecessary.

The query and/or cross node influence 401 (either one of them, the query or the cross node influence, or a combination of the two) could employ the processing pathway shown on the left involving blocks 403, 405, 407 etc. For example, a combination of the query and cross node influence is concatenated into a single textual string and used as input 401 to use that pathway which subsequently culminates in being injected at injection point A 415 into the multi-headed attention block 441.

If a user who is a child has to request a “story for a kid involving a boy named Chuck and his dog named Fred”, the child is not likely to be entering such a long request by typing on a keyboard or even by speaking. Thus, the present invention provides a means to support such queries (such as by children), by the use of fixed templates and appropriate control that specifies the request, for example for a 500 word story (which is used as a control signal 117). In another related configuration, the child is presented by a user interface that provides 5 different buttons (for example) that provides various story patterns such as a race car driver, a sports star etc. Each of those buttons when selected employs a process wherein personalization is factored in, such as names, age, interests etc. Thus using controls, patterns the user request/input is enhanced and embellished with user specific data as necessary. However, instead of just assembling a big long string of data concatenating the enhancements and embellishments, and using it as inputs to a generic AI generation process, which when combined with episode information and chapter structure information, makes it a very complicated long input to a AI based generation machine, the present invention compartmentalizes it by handling pattern data (and other types of influence too) in a special way. For example, based upon recognizing that pattern data or the user query data is a grammatical phrase or a set of phrases, or that the pattern data or query data is just a set of significant words not really related (such as delimited tags) and not in any grammatical order, the appropriate handling of the user requests varies. Muti-headed attention 441 would not be used/invoked if, for example, the query from the user (such as a child) is just a jumble of words. Muti-headed attention 441 is employed when it is determined, for example, that the user's query is a grammatically correct phrase or sentence. Similarly, for patterns, the multi-headed attention may be used for some and not employed for others, based on determination that the pattern is just some jumble of words (likely just a combination of disparate words) and not really part of or similar to a grammatically correct sentence. In one configuration, two different encode pathways fit for processing (attention etc.) and weighting (based on relative importance) the type of influence data are being provided. And, those encode pathways need not be injected at the same point in the decoder, and different injection points may be selected as appropriate. In the same decoder, one influence is injected before and the other one after an attention merger with the feed forward (right shifted word sequence just output). For example, one pathway is where multi-headed attention 441 is used (for example when processing starts at 431) and another where such multi-headed attention 441 is not required and therefore not used.

In one configuration, the query and/or cross node influence 401 (either one of them, the query or the cross node influence) could employ the processing pathway shown on the left involving blocks 403, 405, 407 etc. Similarly, a combination of the query and cross node influence is combined/concatenated into a single string and used as input 401 to use that pathway which subsequently culminates being injected at injection point A 415 into the multi-headed attention block 441.

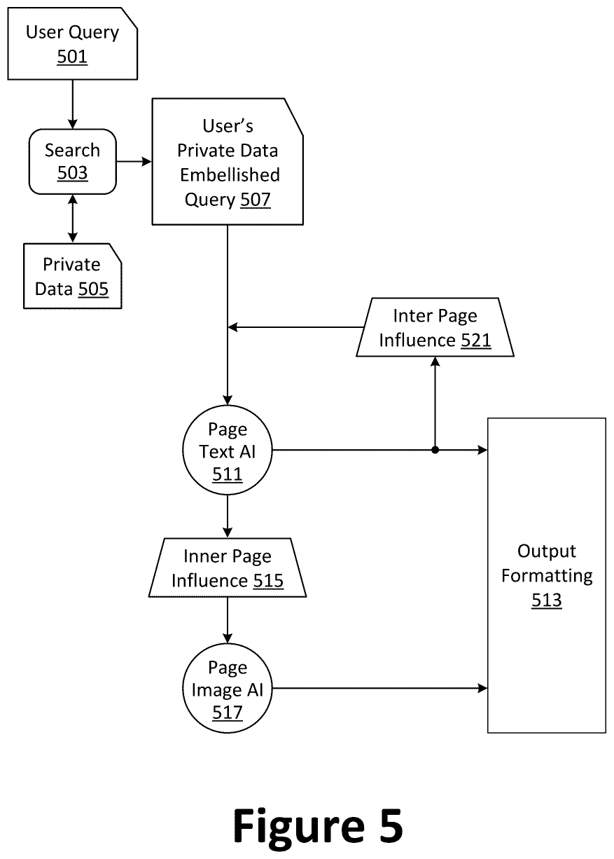

FIG. 5 is a schematic diagram illustrating an exemplary generation of a story book, by an artificial intelligence (herein, “AI”) based generating infrastructure, wherein a user query 501 is received which is used to search a private data 505 to generate a user's private data embellished query 507, and wherein cross-node influence plays an important role in the generation of the anticipated output. Cross node influence is, for example, especially important when facts in one page 521 become relevant in another page (such as a subsequent page), or when one section of a document 515 has bearing on another section of a document. Specifically, if a poem is being written by generative AI, the theme in one stanza may need to influence the creation of a subsequent stanza, or the names of people and places in one paragraph needs to influence the names and places in a subsequent paragraph.

For example, user's private data embellished query 507 is provided as influence to page text AI 511 which not only generates page text needed in response to the query 507, but also outputs an inner page influence 515 that is employed by the page image AI 517 to generate a corresponding image. Both the page text generated by page text AI 511 and the image generated by the page image AI 517 are fed into an output formatting module 513 that combines them as needed (based on pattern influence and control influence, for example) to generate the output comprising both.

Cross node influence can be inter-page influence 521, intra page influence, inner page influence 515, a textual paragraph in one page influencing an image on a subsequent page, an abstract of a document influencing a conclusion section of the same document, an image on one page influencing the textual description of that same image on a subsequent page, etc.

Page text AI 511 receives personalized embellished query 507 is only one part of the AI 511's influence. Inter page influence 521 also influences page text AI 511. This illustrates another pair of influence data in addition to query influence 507. FIG. 5 does not show pattern or control influence, although that can be assumed to be present as needed. Rather it highlights processing that embellishes a user query as one type of influence and cross node (inter-page) influence as another type of influence. In addition, page text AI 511 comprises two different injection points into the AI 511 (not shown), and it is a two input port type of AI with one text output paragraph that is sent to output formatting 513 and is used, and another type of influence which will drive image generation in page image AI 517. Since 511 output is sentence textual, inner page influence 515, which is a cross node processing element such as 125 FIG. 1, processes that sentence received just as module 125 performs of FIG. 1, i.e. it implements operations such as lemmatization, lower case operations, stop word analysis, etc., to get it into a reasonable format for the output generation portion of the AI 517. Both page image AI 517 and page text AI 511 are embodiments carrying forward much of the functionality described in relation to the AI node 101 and other nodes in previous figures.

The user's private data embellished query 507 is stored for subsequent use in some configuration, and used interactively in some other configurations, etc. The private data 505 is local to a user's device in some configurations and is housed remotely in the cloud in some other configurations, and is a combination of locally stored private data and remotely stored private data in other some other configurations.

For example, the user's query 501 might say “give me a poetry book about aliens”, and using that her query 501, the user's private data 505 is searched-by a search node 503, which in a related configuration is an AI based search module. The generated user's private data embellished query 507 is delivered to a page text AI generation 511, which gives an output that is delivered to output formatting 513 and is also delivered as inner page influence 515 to generate an image. Thus page text is used to generate an image 517. Thus, inner page influence 515 acts like an inner segment influence for the page. The output from 511 that is delivered to output formatting 513 is also delivered to inter page influence 521—which uses it to influence the next page of text to be generated.

Inter page influence 521 is used for image generation in some configurations, is used for text generation in some other configurations, and for both in other configurations. Similarly inner page influence 515 is used for image generation in some configurations, is used for text generation in some other configurations, and for both in other configurations.

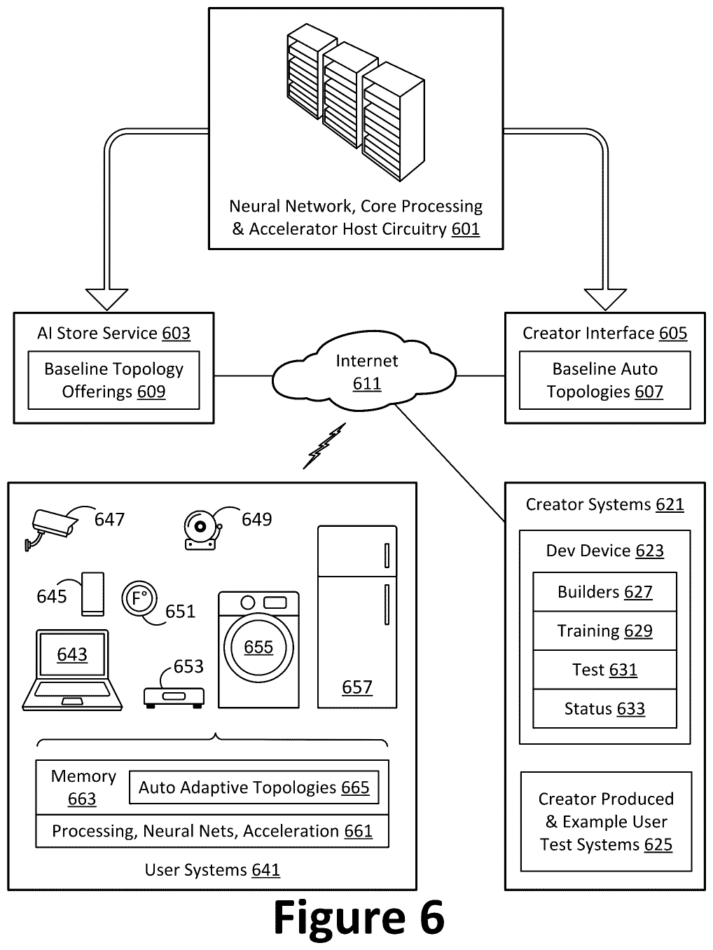

FIG. 6 is a schematic diagram illustrating an exemplary AI based generation environment that uses various kinds of user systems 641 that interact with various kinds of creator systems 621, wherein the environment also provides for a AI store service 603 for storage and access control, and a neural network, core processing & accelerator host circuitry 601 for AI based generation functionality. All the inventions herein in the present application are hosted by the neural network, core processing & accelerator host circuitry 601.

The exemplary systems and circuitry of the trusted artificial intelligence store 603 offering AI (Artificial Intelligence) topology construction provides support for vendors and client with secure output personalization within client devices, in accordance with various aspects of the present invention. Host circuitry 601, provides, with DRM (digital rights management) support and searchable and browsable based selection interfacing, a hosting infrastructure that provides: 1) a generated content hosting service for distributing posted AI generated output; 2) a topology builder hosting service supporting creation of entire AI topologies that include, but are not limited to, sets of host's support processing, trained AI nodes, influence patterns, input interface, and output interface nodes that may be selected in a visual icon based drag, drop and configuration style topology building approach that also supports uploads from and integration with a host provided topology SDK (Software Development Kit); 3) a topology hosting service wherein created AI topologies can be offered for all or select users' own generation desires, with or without personalization support; and 4) a node modification and creation hosting service wherein any type of the hosts supplied topology nodes may be cloned and modified, trained or created from scratch entirely within a provided visual interface or via uploads or interactions via the SDK. Regarding the node modification and creation hosting service, this might include, but is not limited to creation of a modified support processing node by using manual or AI assisted programming modifications to a current host provide support processing node. It may also involve mergers of parts of two or more support processing nodes with or without AI assistance, and so on. Regarding AI nodes, a creator may choose from fully untrained, partially trained AI nodes provided by the host, and train or fine tune train them to achieve an alternate generative output objective. These and other nodes such as influence nodes, outside influence nodes, influence pattern nodes and output formatting nodes, to name a but a few, may be fully replaced or cloned and modified as well to achieve objectives not available from the host's provided node sets.

For all hosting services, rating and commentary support interfaces are provided. Guarantee owners, creators and users (or herein “clients”) an overall safe and trusted environment free from AI supported fraud and other malfeasance, the host circuitry 601 and supporting hosting services are designed employ data flow security, private data compartmentalization, and employ DRM practices along with adequate watermarking and distribution controls with host curation an validation of overall generative AI objectives. Further efforts are made to limit third party hidden malware introduction by monitoring, evaluating and controlling third party topology nodes introductions to detect malware attempts and to identify and prevent associated DRM issues. Curation being key on a node by node and overall topology basis to establish a hosting environment that can be trusted by users, owners, and creators.

To carry this out, the host circuitry contains, for example, training set extraction and selection tools used via a node builder of the creator builder interface. A host's predefined malware free set of support processing nodes, support processing nodes, provide a variety of pre and post processing that may be needed to prepare input or configure output of each of the host's provided AI nodes. The support processing nodes include some that are configurable while others are designed to provide a fixed function.

Public and private data provides for communication security as well as use for third party advertising in an anonymous manner, protecting users, creators and owners from non-curated advertising and other contact reach. For example, an advertiser may deliver a permitted search request along with a desired communication that may reach and group of users, owners or creators. A related hosting service supporting such request may control the format and curate the communication before allowing distribution as users, creators and owners may choose to opt in or out of such flows. Those that do not opt out receive the communication without the advertiser knowing their identity or having access to their contact information. Should particular users, creators or owners respond, the advertiser (or communication sender) can establish their own contact relationships which the responder may deliver via giving at least credential access via their private data within the public and private data.

The public and private data is also used by certain topology nodes to help with topology generation goals as will be illustrated herein with reference to many of the other figures. Similarly, influence pattern nodes are provided for topology building and provide data input that influences an associated AI output generation. Influence pattern data may be textual, image, video, audio, voice and based in any other type of data that an AI node expects as influence input for generating output. AI generations with population readied output and influence patterns may also involve randomized or pseudo-random population the configurations of which being stored within randomization.

Such AI nodes available for inclusion in topologies are host provide, i.e., trained AI nodes. Via a training visual interface provided by the node builder, a creator may train a fully untrained or partially untrained AI node, i.e., untrained AI nodes and partially trained AI nodes. Such training can be based on uploaded and curated training datasets or be based on or extracted from host's training datasets. Curation of training datasets, uploaded topology and topology node related elements and data, and overall topologies are subjected to curation, management and guarantee clearance functionality.

Topologies may be created with a serialized segment by segment approach, at least a somewhat parallelized segmented approach, or created with a single segment design. All approaches may utilize secure partitioning wherein activities on the host side, client (user) side and creator side systems and underlying circuitry are compartmentalized to both distribute processing needs and to help constrain access to private host, client and creator side data, algorithms and AI nodes and topology flow that would be revealed if not for the topology partitioning. For example, a creator may through interaction of the host, require that host provide no access to the creator's topology partition which will be used to service a client topology to which the client may have full access to see the inner workings. The creator may also through interactions with the host define that the client will have limited or no access to the detailed inner workings of the client topology partition. Similarly, a first user that operates a client topology partition via a first user's device may interact in accordance with the client topology partition with a plurality of other users that run copies of the client topology partition on their own devices. Such interactions, as defined by the creator, require secure data exchanges and private information exchange needs can be minimized by the client topology partition's underlying AI and support processing functionality. Chains and tree structures of topology partitioning across devices and systems to perform many needed overall AI generative objectives is also contemplated such as that described in reference to FIG. 4 below.

DRM (Digital Rights Management) functionality involves providing an overall hosting framework in which collection and checking of ownership, authorization, usage rights and related payment collections and shared distributions at every step of node configuration, training and topology generation. At each step and for all creative contributions, rights are admixed with derivative rights included. This process and related curatorship provides a significant value proposition for all involved.

The host circuitry 601 consists cloud infrastructure including racks of neural network circuit elements, core processing elements and accelerators to assist in all of the host processing needs to carry out all of the functionality described herein. Such functionality including but not limited to the AI store service 603 where users interact to gain access to offerings 609 such as (i) AI topologies that they can operate to generate output on demand, and (ii) previously generated output in population readied and fixed format. Users may also interact to manage their accounts, set up secure linkages, and make payments via user management. The creator may for example interact via a creator interface 605 wherein topologies and topology nodes can be defined, configured, uploaded, trained, tested, configured and managed, e.g., via the baseline auto topologies 607. These are just a few of the many interfaces contemplated (many of which are described herein with reference to the following figures) that may be offered to various parties involved by the host circuitry 601.

Although much of the secure communication flow involves Internet 611, intranets, cellular and satellite and any other communication means and infrastructures may replace or be add thereto. User systems 641 each comprising local circuitry are configured with processing circuitry, neural net circuitry, acceleration circuitry 661 and memory 663. The memory 663 comprises auto adaptive topologies 665 from which topology partitions or topology nodes may be defined by an overall topology to provide required functionality to serve an overall AI generation objective. In addition, although not shown, user systems 641 may not only contain secure communication circuitry elements to guard from nefarious data interception and misuse, but may also contain secure portions of the local circuitry such that even software running on the unsecure portion of the processing circuitry 661 cannot snoop or interfere with ongoing topology related operations or data storage related thereto. Moreover, output player related circuitry (and other output related circuitry) may be secured such that key based security can ensure that output from a topology only reaches output circuitry of any sort with an internal secure pathway. Again, this prevents any nefarious software running on the unsecure portion of the processing circuitry 661 from snooping, copying or modifying the topology generated output.

User systems 641 takes the form of a laptop 643, a refrigerator or other home appliances 657, a washer or dryer 655, an over, a CD player/blue ray player 653, a mobile device 645, a music player 649, a vacuum 647, a temperature control unit 651, as appropriate. Other forms of user systems 641 in various form factors are also contemplated.

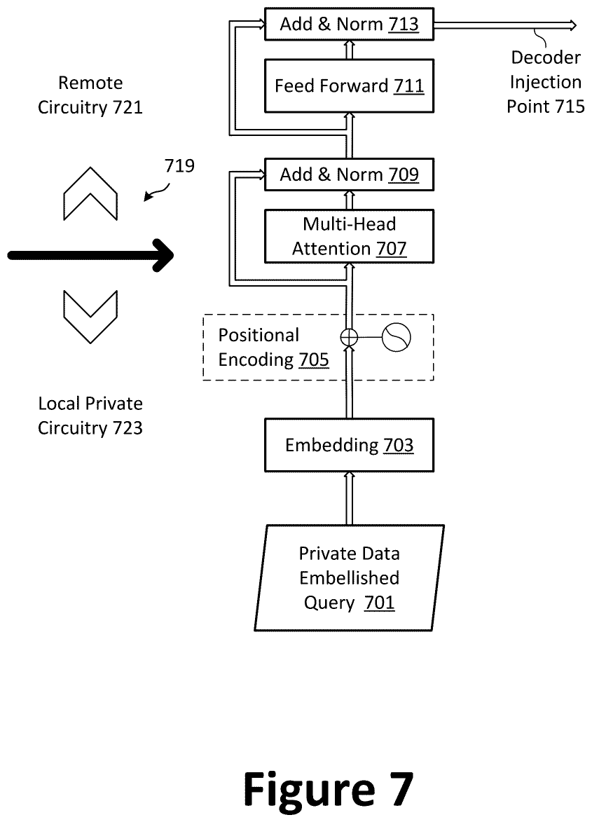

FIG. 7 is a schematic diagram illustrating an exemplary encoder portion where injection functionality 719 provides for flexible injection of influences into remote circuitry 721 or to local private circuitry 723. The injection point can be completely on the host, i.e. remote circuitry 721, or all on the user device, i.e. local circuitry 723, or it could be anywhere in between (split between the two circuitry 721 and 723).

For example, in one configuration, embedding and positional encoding are conducted by a local private circuitry 723 with remote circuitry 721 optionally conducting some or all of the encoder processing such as multi-head attention 707 and normalization 709, etc. Thus, instead of injecting influences at the multi-head attention 707, it can inject influences before that, if necessary, at positional encoding 705 or after the multi-head attention 707 before the Feed Forward 711.

In one embodiment, a flexible split between generative AI processing in remote and local systems is achieved. Moving part of the AI generation functionality out of the local realm and to the host side is achieved to take advantage of powerful remote AI systems while also providing localization functionality as well as some degree of anonymity. For example, when dealing with local user query embellishment based on private data, a private data embellished query 701 may not be needed to be sent to the remote host system. Just the top part of the decoder can be there at the remote circuitry/remote host system 721. However, anonymity is critical and can be achieved by processing locally to some extent at the local private circuitry 723, and some configurations of an AI models are implemented wherein the encoder side processing actually masks the private info of a user data and query in preprocessing operations before sending the result to a remote host system 721. Such sending of partially processed data to influence the host decoder portion is flexible and useful wherein powerful remote system 721 can be used for decoding.

In one configuration, the bottom few portions of the decoder are conducted locally and only the upper portion of the decoder is hosted remotely and only one word only is output at a time at the decoder, and the entire context of the query and generation process is mostly hidden from the hosted remote system. This offers better anonymity than in the configuration where the entire decoder portion is located at the remote host system, wherein the host will need to see the decoder's previous output in full, etc. with a resultant loss of some anonymity.

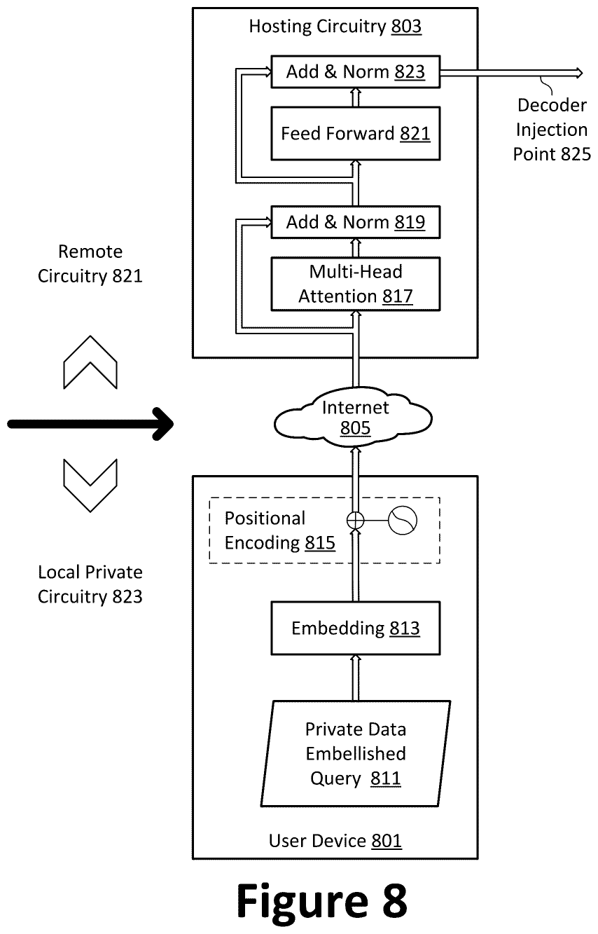

FIG. 8 is a schematic diagram illustrating an exemplary encoder portion wherein injection of influences are split between the hosting circuitry 803 and the user device 801. For example, a low power user, such as a cell phone, or other a low powered internet of things (IOT) device, employs a hosting circuity for some part of encoding as well as for decoding. The low powered user device 801 would conduct embedding and positional encoding locally, using a private data embellished query 811 as necessary. Thus, the private data embellished query 811 is embedded and encoded on the local private circuitry 823 of the user device 801, before it is sent across the Internet (or other secure communication pathway/means) for further processing, ensuring that the user's private data is never exposed, never in naked form, to provide anonymity. The rest of the encoding occurs in the remote circuitry 821 of the host circuitry 803, as necessary.

In one embodiment, a flexible split between generative AI processing in remote and local systems is achieved. Moving part of the AI generation functionality out of the local realm and to the host side is achieved to take advantage of powerful remote AI systems while also providing localization functionality and private data incorporation as well as some degree of anonymity. For example, when dealing with local user query embellishment based on private data, a private data embellished query 811 may not be needed to be sent to the remote hosting circuitry 803 system. Just the top part of the encoder (as well as the decoder) can be located at the remote circuitry/remote host system 803 which performs multi-head attention processing 817, normalization 819 before injecting into a decoder at decoder injection point 825.

Since anonymity is critical and can be achieved by processing locally to some extent at the local private circuitry 823 (which is in user device 801), and some configurations of an AI models are implemented wherein the encoder side processing actually masks the private info of a user data and query in local preprocessing operations, before sending the result to a remote hosting circuitry 821 (in hosting circuitry 803) for further encoding and subsequent injection into a decoder. Such sending of a partially processed encoded data to influence the host encoder portions and decoder portions is flexible and useful wherein powerful remote system that are available are flexibly employed.

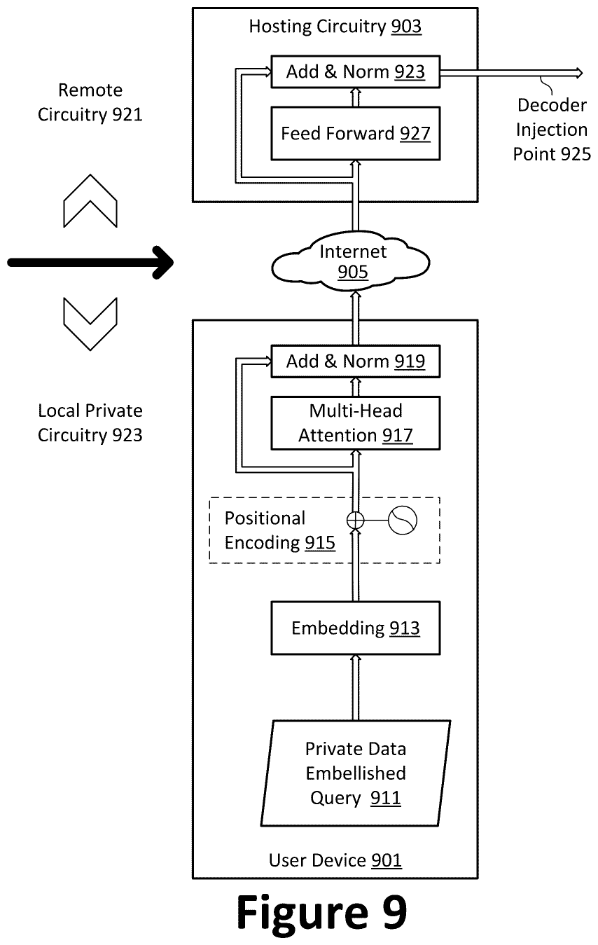

FIG. 9 is a schematic diagram illustrating an exemplary encoder portion wherein injection of influences are split between the hosting circuitry 903 and the user device 901, and the feed forward operations are conducted remotely at the hosting circuitry 903. For example, a low power user device 901 would not only conduct embedding and positional encoding locally to achieve some level of anonymity while using local private data, using a private data embellished query 911 as necessary, but also conduct multi-headed attention 917 processing locally before sending the data to hoisting circuitry 903 for feed forward processing 927 and normalization 923. Thus the private data embellished query 911 is embedded and encoded on the local private circuitry 923 of the user device 901, and also processed by the multi-heads attention 917 before it is sent across the Internet (or other secure communication pathway/means) for further processing, again ensuring that the user's private data is never exposed, never in naked form. The rest of the encoding such as feed forward processing occurs in the remote circuitry 921 of the host circuitry 903, as necessary. This mode of processing of query and influences sent up to the host circuitry 903 by the user device 901 is applicable to not just private data embellished query 911, but also to patterns, control, and cross-node influences, that are also handled and forwarded in encoded private mode. Each of those influences can be split in different ways individually between/across the hosting circuitry 903 and the user device 901. Each of them have their own pathway with its own mode of splitting the influences. The neural network itself might be split with some part of the neural network being executed in the user device 901.

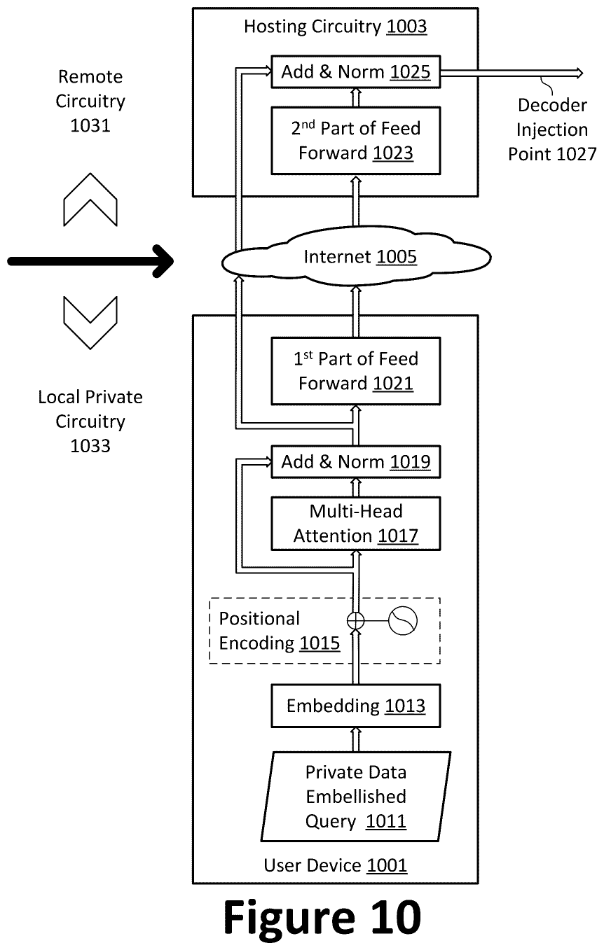

FIG. 10 is a schematic diagram illustrating an exemplary encoder portion wherein a neural network is split between the hosting circuitry 1003 and the user device 1001 wherein anonymity is achieved by not storing query and output at the hosting circuitry 1003, while also benefitting from use of powerful processing capabilities of the hosting circuitry 1003. The hosting circuitry 1003 not only conducts decoding but also a portion of feed forward operations 1023 based on query and influences received from the user device 1001 after anonymity is ensured by the user device 1001. As necessary, injection of influences is also split between the hosting circuitry 1003 and the user device 1001. For example a low power user device 1001 would not only conduct embedding and positional encoding locally, using a private data embellished query 1011 as necessary, but also conduct multi-headed attention 1017 processing locally, and even conduct part of the neural network processing locally employing a 1st part of Feed Forward 1021 before forwarding the results to the hosting circuitry 1003 for further processing employing a 2nd part of Feed Forward 1023. The 1st part of Feed Forward 1021 is located and conducted in the user device 1001 while the 2nd part of Feed Forward 1023 is located and conducted in the hosting circuitry 1003. In the combined functionality provided by the 1st part of Feed Forward 1021 and the 2nd part of Feed Forward 1023, the nodes are cycled locally as needed, and data always flows in one direction, i.e. the input is only processed in one direction and never backwards/opposite.

In a multi-layer neural network implementation, in one exemplary configuration, with the feed-forward technique in accordance with the present invention, some of the layers are implemented in the 1st part of Feed Forward 1021 while the rest of the layers are implemented in the 2nd part of Feed Forward 1023. For example, forward propagation of input signals (received, for example, from the Add & Normalization 1019) to the neurons in a first hidden layer of the 1st part of Feed Forward 1021, the activation of the node is locally calculated, for example based on a tanh function, before its vector output is forwarded securely to the 2nd part of Feed Forward 1023 over Internet 1005.

For example, a subpart of the overall neural network, in one configuration, is fully trained by the host circuitry 1003 and then migrated to the user device 1001 to be conducted as the 1st part of Feed Forward 1021.

For example, a first column of a matrix data of the neural network, in another configuration, is processed in the user device 1001 by the 1st part of Feed Forward 1021, while the other columns are processed by the host circuitry 1003 employing the 2nd part of Feed Forward 1023.

For example, in one configuration, after the multi-head attention 1017 processing is complete, normalization 1019 is conducted, following which a 1st part of feed forward 1021 is conducted locally in the user device 1001 before the partially processed data and influence is communicated securely over internet 1005 to the host circuitry 1003, where the 2nd part of feed forward 1023 is conducted prior to being injected into the decoder at a decoder injection point 1027.

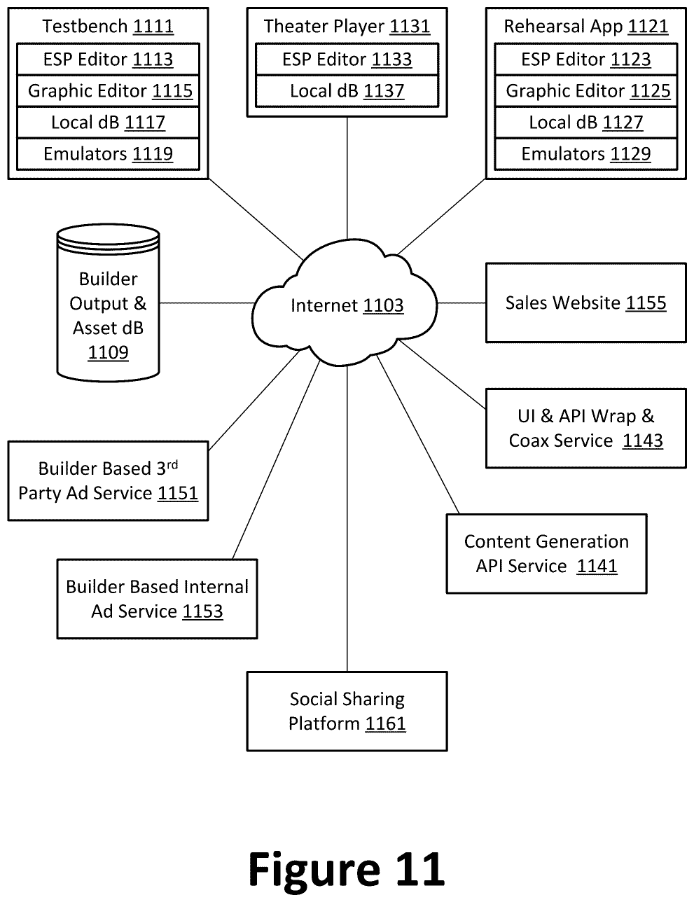

FIG. 11 is a schematic diagram of a content generating and theater play infrastructure that comprises a theatre player 1131 used to experience animations and other digital content in a theatre like setting, a testbench 1111 where a content creator can test the quality and appropriateness of a created content prior to its curation or sharing, a builder output & asset dB 1109 that is used to store assets and curated outputs, a builder based 3^{rd} party ad service 1151, a rehearsal app 1121 that is used to optionally enhance or modify a content and play it to check its performance, and a builder based internal ad service 1153.

A 3D actor model, such as those for a famous celebrity movie star such as Arnold Schwarzenegger, is often used to provide the consumer of generated content an opportunity to have their favorite movie star “act” in their content, such acting driven by voice and movement/animation facsimile of the celebrity movie star. Thus the generated content incorporating Arnold Schwarzenegger's voice and 3D model (with appropriate rigging) is provided to some users of the theater player 1131, while a different player who prefers Tom Cruise to be the 3D model in another version of the same generated content will experience it in the theater player 1131 with Tom Cruise model being used for display and animations.

The testbench 1111 typically runs on a PC but it does not have to run on a PC—it can run on mobile devices and also the internet cloud in some configurations. It works better in a setup that comprises a giant screen for ease of use. The ESP editor 1113 facilitates making changes, while the emulator 1119 makes it possible to see the impact of those changes on different devices such as an android device or an ioS device. The graphic editor 1115 also comprises a theatre player functionality in some configurations.

The theatre player 1131 does not require an ESP editor in some configurations. In its core, it comprises a 2D or 3D animation platform such as an UnReal engine. The user who interacts with it visually sees an animation that will seem like a 3D video, even though the data required for its operation is substantially less than would be required for a video. Video streams are typically delivered or displayed such that it cannot be dynamically changed, whereas the animation of models by the theatre player 1131 makes it possible to dynamically modify nor alter the flow of the visual display, if necessary. The functionality of the ESP editor 1133 in the theatre player 1131 is constrained or restricted based on the age of the user. So a toddler does not get to use its full functionality, while an adult might be allowed access to the ESP editor's 1133 full functionality, etc.

The builder output & asset database 1109 makes it possible to store and reuse, as appropriate and necessary, the assets (audio, video, images, text, music, etc.) that get presented as part of curated content. It makes it possible to incorporate various assets dynamically into various content presented by the theatre player 1131 such that the overall presentation to the user would be not only interactive but also more efficient than a video that is played back to a user.

An ESP editor such as 1133 also allows creation of a new content by a user, for a charge or a few, wherein the user just provides a minimal description of what he needs and the ESP editor runs its processing to generate the require content, which can then be staged in incremental delivery fashion, with a textual content initially, and a animated version subsequently following user approval (for example). The final animated version may be played back for the user by the theater player 1131, and also stored for future use at the builder output & asset dB 1109.

Any change, even a minor line change, by a user makes (or the parent in the case of a minor or child) using the theater player 1131, will have a cost associated, such as a micro fee, that the user or the user's parent will have to pay for. After approval by the user or the adult inn charge of the user such as a parent, modified content is created or new replacement content if regenerated, as necessary. Change in costumes for one or more characters, change is some dialogues, change in props are supported, with associated fee charges.

The ESP Editors 1113, 1133, 1123 also make it possible for a user to introduce a new object, create a model for it, rig its movements, perhaps to be in synchronous with the movements/animations of another object/rigged model that is already part of a current animation.

The rehearsal app 1121 can be used by a director of an animation, to specify movements, advice on interactions, tune up character movements, make pauses in movements, change logic modules that dictate interactions, etc. The ESP editor 1123 and the Graphic editor 1125 may be dumbed down versions of the ESP editor 1113 and the Graphic editor 1115, to make their operations easier and less complex for a user.

Advertisements can be assembled as JSON files with associated assets that are saved in the builder output & asset dB 1109. Voice files, if any, will be stored as compressed assets. Content generator 1141 is used to create new content, modifications to content, generation of content for advertisements, etc. Such content generations might also be managed using the UI & API wrap & coax service 1143, which would setup and manipulate interactions with external genAI content generators (or other transformers). If a user using the theater player 1131, or a director using the rehearsal app 1121, changes one line of a dialogue, then generation of a new voice/audio content based on the change of that one line will involves the use of the content generation API service 1141 for retrieval of new/revised/modified audio component. The new audio component might replace an older component, thus resulting in a private derivative work.

If the changes to an existing content, such as changing of a character of a storyline, is substantial, then regeneration of the whole content might be necessary, and there will be a charge to the user for creating such significant modifications. The user might not approve of this in which case it will be abandoned. If the user approves those charges, then regeneration is kicked off, and the resultant content (animated story or a joke etc. in most cases) is tracked as a private branch or derivate work.

For displaying an ad to a user, the actors that the user already has in his/her portfolio will be used to assemble/generate the animation of the advertisement, the actors perhaps randomly selected in some situations, along with random props that user might be familiar with. In some situations, the use of a voice of a celebrity or the use of the movements of the celebrity is restricted to one or more runs, and will be terminated after that, with other default characters and their corresponding voice files being used thereafter for the same advertisement.

ESPs generated will be stored in the builder output & asset dB 1109. These are then retrieved and used by ESP editors in the theater player 1131, testbench 1111, rehearsal app 1121, etc. They can then be made locally available in corresponding local db 1137, m1117, 1127 etc.

Using the content generating and theater play infrastructure, users can succinctly specify what they want, for example by providing an abstract storyline, a story conclusion, optionally some character names and target age to generate a screenplay that can be viewed or experienced by a child (or teenager). The various subsystems of the infrastructure processes that user provided input to generate the necessary assets. These assets are then dynamically assembled and played back by the theatre player 1131 to be viewed by a user (such as a child) as personalized content.

In some configurations, sharing the user's generated content with other users can result in generating revenues, which may can shared with the user. Thus selectively, successful storylines or other types of content created and shared by the user can generate revenues for the user. Thus, users share profits when we enable them to make videos and animations etc. just by acquiring a few lines of inputs from those users.

The testbench 1111, the theatre player 1131 as well as the rehearsal app 1121 comprise a ESP editor 1113, 1133 and 1123 respectively. In addition, both the testbench 1111 and the rehearsal app 1121 comprise a graphic editor 1115, 1125 respectively. Similarly, the local database of assets and curated content 1117, 1137 and 1127 respectively provides local assets and related information that is used to generate appropriate types of dynamic content for viewing by a user.

The builder output and assets database 1109 is therefore a centralized repository for storing all generated content, assets, and metadata. It connects to the Internet 1031, enabling remote access, synchronization, and backup. This database 1109 supports the rehearsal app 1121, content generation API service 1141, and other components by providing necessary data assets and resources.

The builder based internal ad service 1153 generates and manages advertisements for internal use within the system. Connected to the Internet 1103, it collects user data and content performance metrics to create targeted ads. These ads are displayed on the sales website 1155 and integrated into the theater player 1131.

The builder based third-party ad service 1151 operates similarly to the internal ad service 1153 but focuses on advertisement needs for new services and products released or made available via the infrastructure. It also, in come configurations, supports third-party advertisements. It connects to the Internet 1103 to source and manage ads from external advertisers, delivering them to the sales website 1155 and other ad-supported components within the system.

In summary, FIG. 11 presents a comprehensive and interconnected system where each component plays a specific role in the creation, management, distribution, and promotion of digital content. All components are linked through the Internet 1031 to enable seamless functionality and integration, ensuring an efficient and cohesive ecosystem.

The user's input for content generation is a grammatically proper sentence and a few constraints that may be expressed as tags or as parameters. Wrappers are then created using the user's inputs and the constraints, such as age appropriateness, anti-divisive nature of output required, adult content screening level, etc. that are to be used by generative AI components, such as encoding modules. Thus, in the encode pathway there needs to be preprocessing where different constraints and the user inputs (such as user provided grammatically proper text) too are likely to be processed or incorporated differently. The constraints may be inserted as an entry or user input that is handled using tags. These tags are pre-processed differently from user inputs provided as text, for example. And they are also processed differently in the encoding pathway. In one configuration, attention mechanisms are not beneficial and therefore not employed, and neither are downgrading of words or exclusion of words necessary. After pre-processing, a wrapper is created using user's textual inputs and tags created from constraints and other parameters.

The content generation API service 1141 makes it possible to interact with remote genAI servers that support a SDK for such interactions, with coaxing support for generation of certain types of output, wherein coaxing is typically extra fields given by the SDK that need to be provided with proper inputs or parameters. As opposed to the coaxing fields, the wrapper that is provided as input to genAI processing comprises a user request (often in textual form) that is enhanced with other texts and tags that influence generation of text at a genAI processing service.

The content generation API service 1141 provides access to remote genAI servers, that take requests and return responses. The remote API service 1141 provides a structure to allow forwarding of user provided request, along with special request structure for constraints and parameters that guide the generation process, wherein some of the constraints or parameters might have separate entry points during the processing of genAI requests at the remote server. So the present invention defines a coaxing operation wherein the special request structure is populated and presented for processing by remote genAI servers. Such coaxing is in addition to “wrappers” comprising extra guidance, constraints and clarifications that is used to influence the generative AI processing, that is clubbed together in the form of a combined wrapped input. These wrappers may be framed in a specific from or template in some configurations.

Similarly, using the same stored assets or curated content, different appropriate AI models may be used for different consumers based on their age (or age group). In one configuration, coaxing operations would involve using tools that the AI content generator SDK 1145 provides. Then we have our wrappers that also provide a proper way to constrain or guide content generation. However, such wrappers can be broken down and parts thereof fed into different injection points of the AI generating infrastructure. The content generating and theater play infrastructure makes it possible to use the same common data (for example a user's data or corporate data), to train different AI models for different purposes or roles. Thus a whole set of different models may be created, each for a different purpose or for a different user role. For example, a common corporate data may be used to train one AI model for one employee who works as a procurement person, another AI model support a role of a supplier contact, and yet another AI model for a role as a customer support person. etc. Each of individuals who work in those roles may not have required domain experience, nor have required understanding of corporate policies, but their corresponding AI models provide them with the necessary deterministic decision making and generative support and appropriate models based on the same underlying data.

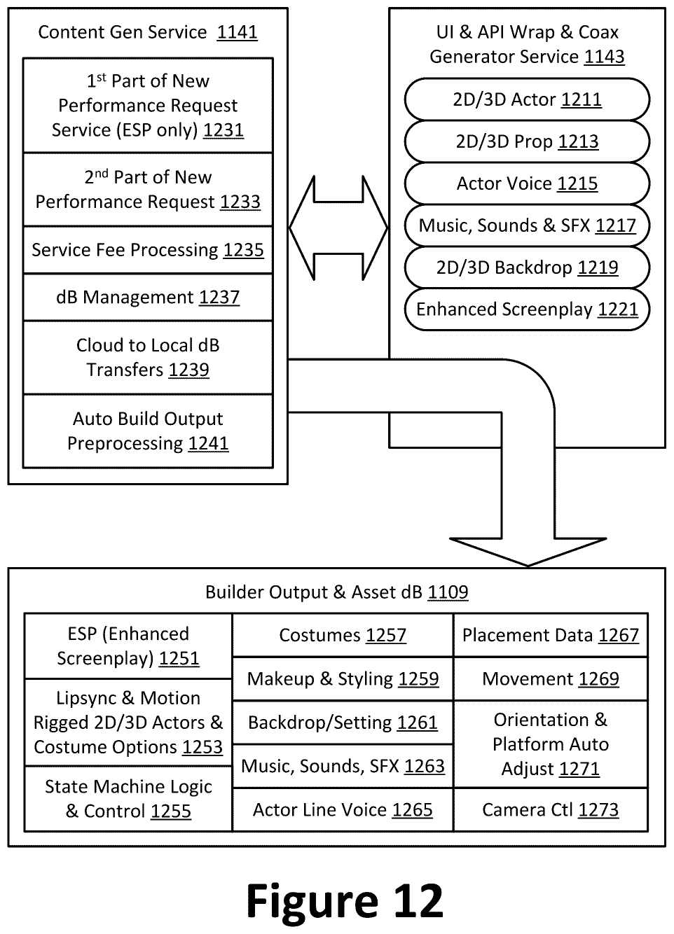

FIG. 12 depicts an integrated system architecture involving various components interconnected through the Internet, with interactions on the backend with the build output & asset dB 1109. These components such as content generation API service 1141 and the UI & API wrap & coax generator service 1143 collectively facilitate the development, management, and distribution of digital content such as animations, with a focus on generating and processing performance requests and associated assets.

The UI and API wrap & coax generator service 1143 makes a request and pursuant to that, the content generator API service 1141 interacts with an external or internal genAI service in order to retrieve models, rigging, audio segments, voice segments, music, images, etc., which are then stored in the builder output & asset db as assets. In addition, ESP are also stored in builder output & asset dB 1109, and user specified celebrity actor models with accompanying rigging and voice data are stored too. Backdrop for various scenes of a content, voices etc. get generated with interactions with the an external or internal genAI service, through use of SDK coaxed with wrapped techniques, which are then stored. The UI and API wrap & coax generator service 1143 interacts with internal AI generation models, and or with external ones, the outputs being received by the content generator API service 1141, which are then stored in the builder output & asset dB 1109.

The builder output & asset dB 1109 stores all kinds of information for animated content, such as ESPs 1251, costumes 1257, placement data 1267, lipsync & motion rigged 2D/3D actors & costume options 1253, state machine logic & control 1255, music, sounds, SFX 1263, makeup and styling 1259, actor line voice 1265, orientation & platform auto adjust 1271, movement details 1269, etc. Actor looks and feel and clothes may be changed using the assets in the database 1109, and state machine logic determines movements scene-by-scene, and withing each scene. Similarly camera relocations can change scene by scene and this information is also stored to be retrieved in appropriate segments of a generated content when it is played back by a user.

For example, is a forest setting, the scene might start with a wide angle with characters shown in small shape. Then when a close up of an actor needs to be shown subsequently, the screen if divided into 1 to 4 sections, and the actor's model is zoomed into, in one of those sections, with the camera orientation and position changed accordingly. The background will require a new or separate backdrop when such zooming of a character's model becomes necessary.

The content generation service 1141 is responsible for creating and managing digital content. It includes several sub-components such as the first part of new performance request service (ESP only) 1231, the second part of new performance request 1233, service fee processing 1235, database management 1237, cloud to local database transfers 1239, and auto build output preprocessing 1241. The first part of new performance request service 1231 handles initial requests for new performances specifically related to enhanced screenplay (ESP) content. The second part of new performance request 1233 completes the request process by incorporating additional data and specifications. Service fee processing 1235 manages the financial transactions associated with content requests. Database management 1237 ensures efficient handling of content-related data, while cloud to local database transfers 1239 facilitate the movement of data between cloud storage and local databases. Auto build output preprocessing 1241 prepares the content for further processing and final output.

The UI and API wrap and coax generator service 1143 interfaces with the content generation service 1141 to handle various elements of the performance content. This service includes components such as 2D/3D actor 1211, 2D/3D prop 1213, actor voice 1215, music, sounds, and SFX 1217, 2D/3D backdrop 1219, and enhanced screenplay 1221. The 2D/3D actor 1211 component deals with creating and managing two-dimensional and three-dimensional characters. The 2D/3D prop 1213 handles the virtual props used in performances. Actor voice 1215 processes the audio elements related to character voices. Music, sounds, and SFX 1217 manage the auditory aspects of the performance content. The 2D/3D backdrop 1219 provides the background settings for performances, while the enhanced screenplay 1221 integrates all these elements into a cohesive performance script.

Both the content generation service 1141 and the UI and API wrap and coax generator service 1143 feed into the builder output and assets database 1109. This centralized repository stores all generated content, assets, and metadata. Within the builder output and assets database 1109, several specific types of data are managed, including ESP (enhanced screenplay) 1251, lipsync and motion rigged 2D/3D actors and costume options 1253, state machine logic and control 1255, costumes 1257, makeup and styling 1259, backdrop/setting 1261, music, sounds, SFX 1263, actor line voice 1265, placement data 1267, movement 1269, orientation and platform auto-adjust 1271, and camera control 1273. The ESP 1251 component contains the enhanced screenplay data. Lipsync and motion rigged 2D/3D actors and costume options 1253 manage the animation and attire of characters. State machine logic and control 1255 governs the behavior and interactions of characters and elements. Costumes 1257, makeup and styling 1259, and backdrop/setting 1261 provide visual and stylistic elements for characters and scenes. Music, sounds, SFX 1263, and actor line voice 1265 manage the auditory components of the content. Placement data 1267, movement 1269, and orientation and platform auto-adjust 1271 handle the spatial and positional aspects of characters and objects. Camera control 1273 manages the viewpoints and perspectives used in the content.

In summary, FIG. 12 presents a detailed view of an integrated system for generating, managing, and processing digital content and performance requests. The components work together through the Internet to create a cohesive and efficient workflow for producing high-quality digital performances and related assets. Each component plays a critical role in ensuring that the final output meets the desired standards and specifications.

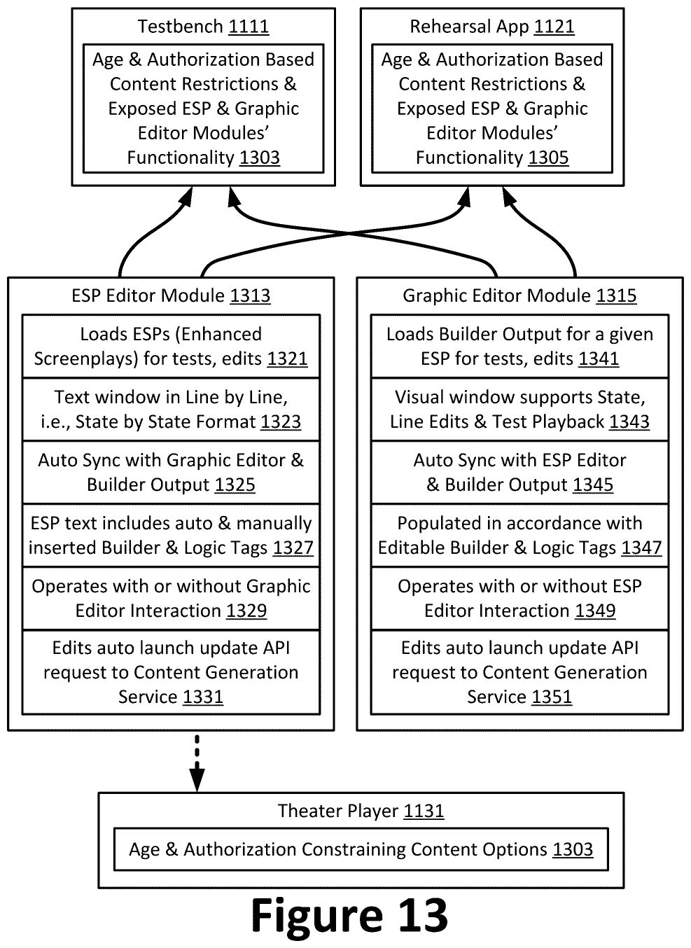

FIG. 13 depicts an interconnected system architecture involving various components essential for developing, managing, and editing digital content, such as a testbench 1111 and a rehearsal app 1121. These components are integrated through specific modules and functionalities to ensure a seamless workflow. The testbench 1111 typically runs on a system with a large screen such as a PC or laptop. The rehearsal app 1121 is used by a director to make changes to a created content such as a screen play, in order to fix problems, make the visual user experience better, etc.

The testbench 1111 comprises age & authorization, defining exposed ESP & graphic editor modules' functionality 1303. Such functionality is incorporated into a webtool or web-based testbench 1111 in one configuration. Similarly, the rehearsal app 1121 comprises age & authorization, defining exposed ESP & graphic editor modules' functionality 1305, and it runs as a webtool or web-based app in one configuration.

The ESP Editor module 1313, that is typically part of the testbench 1111 and the rehearsal app 1121, loads ESPs for tests, for editing etc. 1321. It also facilitates viewing in a text window in a line by line mode, or in a state by state format of a state machine 1323. It is capable of auto syncing with the graphic editor model 1315 and the builder output 1325, to save changes made. The ESPs are usually text that include auto and manually inserted builder & logic tags 1327. The ESP Editor module 1313 may operate with or even without graphic editor interactions 1329. Any edits made to ESPs or to models in the ESP editor module 1313 may auto launch update API requests to Content generation service 1331.

The Graphic editor module 1315 comprises many model manipulation and storage functionality. It loads builder output for a given ESP for testing purposes or for editing 1341. It provides a visual window to support State edits, Line edits & to test playback 1343. It is capable of auto synching changes with ESP editor & builder output 1345. It gets populated with relevant data in accordance with editable builder & logic tags 1347. It operates with or without ESP editor interaction 1349. Edits made using the graphic editor module 1315 may auto launch update API request to the content generation service 1351.

The testbench 1111 is an environment designed to test and validate different functionalities within the system. It includes age and authorization-based content restrictions and exposes the functionality of the ESP and graphic editor modules 1303. These restrictions ensure that content is accessible only to authorized users and adheres to age-appropriate guidelines. The testbench 1111 interfaces with other components to provide a controlled environment for testing and development.

The rehearsal app 1121 offers tools and functionalities for rehearsing and fine-tuning digital performances. Similar to the testbench 1111, it includes age and authorization-based content restrictions and exposes the ESP and graphic editor modules' functionality 1305. This ensures that rehearsals are conducted with appropriate content and user access controls. The rehearsal app 1121 connects to the broader system to facilitate rehearsal activities and content editing.

The ESP editor module 1313 is responsible for loading enhanced screenplays (ESPs) for tests and edits 1321. It provides a text window in a line-by-line format, i.e., state-by-state format 1323, enabling detailed editing and review of the screenplay content. This module auto-syncs with the graphic editor and builder output 1325, ensuring that changes made in the ESP editor are reflected across the system. The ESP text includes both automatically and manually inserted builder and logic tags 1327, which are essential for the accurate representation of the content. The ESP editor module 1313 can operate with or without interaction with the graphic editor 1329, providing flexibility in the editing process. Additionally, it edits and auto-launches update API requests to the content generation service 1331, streamlining the workflow and ensuring that updates are processed efficiently.

The graphic editor module 1315 is designed to load builder output for a given ESP for tests and edits 1341. It features a visual window that supports state, line edits, and test playback 1343, allowing users to visualize and interact with the content. This module also auto-syncs with the ESP editor and builder output 1345, maintaining consistency across different components. The graphic editor is populated in accordance with editable builder and logic tags 1347, which guide the editing process. Similar to the ESP editor module 1313, the graphic editor module 1315 can operate with or without interaction with the ESP editor 1349. It also edits and auto-launches update API requests to the content generation service 1351, ensuring that changes are propagated throughout the system.

The theater player 1131 is designed for the playback of digital content, particularly for theatrical or cinematic presentations. It includes age and authorization-constraining content options 1303, ensuring that the content played is suitable for the audience and adheres to access controls. The theater player 1131 interacts with other components, such as the ESP editor module 1313 and the graphic editor module 1315, to provide a seamless playback experience.

In summary, FIG. 13 presents a comprehensive and interconnected system architecture where each component plays a specific role in the development, management, and playback of digital content. The components are integrated through modules and functionalities that ensure a seamless workflow, from content creation and editing to testing and final presentation. All components work together to provide a controlled and efficient environment for handling digital content, ensuring that it meets the desired standards and specifications.

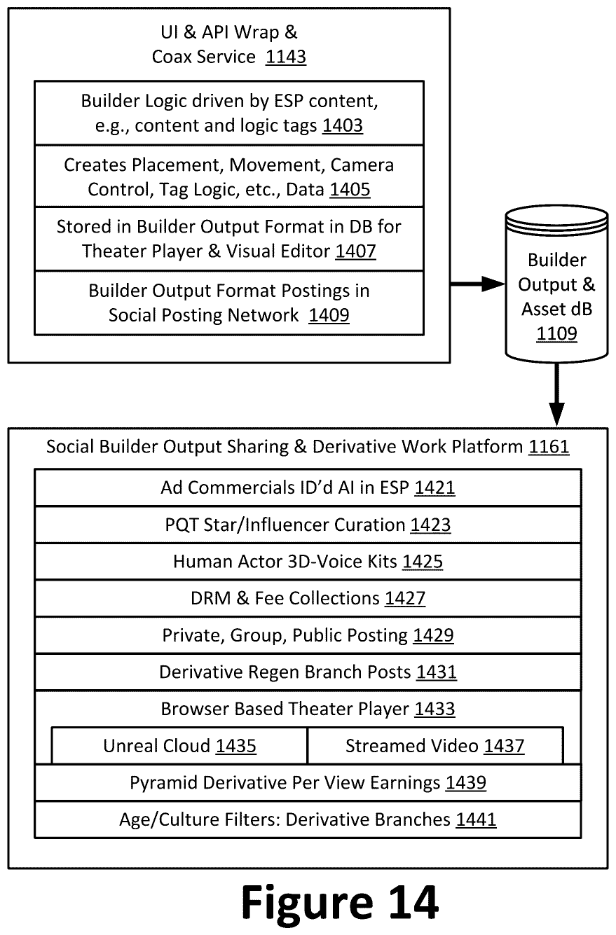

FIG. 14 depicts exemplary interactions between a UI & API wrap & Coax service 1143 and a builder output & asset dB 1109, which results in triggering activities in the social builder output sharing & derivative work platform 1161. The UI & API wrap & Coax service 1143 employs the builder logic when driven by ESP content 1403, such that content and logic tags are determined for use during interactions with external or internal genAI servers. It also uses Data 1405 such as placement data created, movement, camera control data, tag Logic, etc. in its wrappers. The Ui and API wrapping and coaxing service 1143 is accessed from the theater player and Visual editor 1407 when necessary, as its connections are stored in builder output format in the DB. Similarly, social posting network 1409 may have posts or content provided in builder output format, which when triggered will result in interactions with the UI & API wrap & Coaz service 1143.

The social builder output sharing & derivative work platform 1161 facilitates presenting of ad commercials whose IDs and details are specified as ESP 1421. It conducts PQT star/influencer curation 1423. It supports use of human actor 3D-voice kits. It enables DRM based access control and fee collections 1427. It supports private, group based and even public posting of content (animated storylines, screen plays, jokes, ads, music, poetry etc.) It also facilitates creation of derivative work, that might involve regeneration, and also playback of derivative work. Posts containing derivative works may be made by an authorized user after fee payment.

The social builder output sharing & derivative work platform 1161 also supports browser based theater player operations 1433. It may optionally employ a cloud based Unreal engine 1435, and also store or share content as a streaming video 1437.

A user can select one derivative work from a pyramid of derivative works for playback/viewing, or even create a derivative work himself/herself so that it can be shared and revenues earned. Such pyramid derivative per view earnings 1439 are presented to the suer, such as in a dashboard. In order to provide age appropriate and culture appropriate derivative work versions to users, age/culture filters 1441 are provided such that only relevant filtered branches of derivative work are accessible by a user.

A tree or pyramid of derivative works may get created when different users create personalized versions starting with a common original content, each modifying some portion (small or large) as required to create a derivative work, which they can either choose to share with others to get paid, share with others such as family members without any additional fees, or put them in the public domain. One derivative work by one user may be further modified by another user, thereby creating a chain of derivate work, each with its own originator, each with its own owner who can setup a payment system for others who want to view it or derive additional derivative works.

The social network aspect of the present invention comprises creating content, sharing the content in private more or public mode or with groups, optionally getting paid for the content by people interested in viewing that content. Micro transactions are supported in some configurations for such payments. In addition, the theater player itself can be hosted in the cloud and facilitate access and playback of shared content such as stories, dramas, music concerts, jokes, educational material, training material and other viewing experiences. DRM and fee collections 1427 provides authorization and revenue generation means for content creators.

Social network based sharing factors in age constraints and cultural constraints when the shared content are accessed in a country or region where social norms and cultural values are different from those of the region or country where the content was created. In addition, human actor 3D voice kits that are more familiar and in line with the culture and age of the content experiencing person (one who is consuming the content) can be used to replace a default actor's 3D voice kit. For example, if a content created in Los Angeles comprises a human 3D voice kit of Tom Cruise, the same content when played or experienced by a user in India might employ the human actor 3D voice kits of Shah Rukh Khan, for example.

The Personality, Quirks, Tendency (PQT) for human 3D actors or even for fictional characters may be predefined such that they get used when such 3D actors are incorporated into a storyline of content of some kind. In one configuration, PQT tag insertion by ESP Producer makes it possible to dynamically influence a storyline being played. In some configuration, predefined PQT in 3D Rigged AIctor (i.e. AI based actor model) model is incorporated in crafting the ESP text. PQT for character AIctors approach if not provided as part of the 3D AIctor model, will trigger the ESP Producer to define PQT characteristics from available rig motions and then cause them to add appropriate tags (tags responded to in the State of the Builder Output).

The social network aspect of the present invention also incorporates being able to send “wrapped” actor line-text to a 3^{rd} Party AI voice generator such that replacement voice content can be provided dynamically to select users viewing a content from a node in the derivative tree of a content. Such wrapping selectively includes ESP defined actor line volume and emotion too in some configurations. ESP parameters (e.g., emotion) drives speaking style, such as for example, whisper, normal, fast, slow, monotone, emphasis positioning. As with all content, voice output (mp3 files for each line, or other similar storage formats) are JSON referenced & stored as an asset by the Content Gen Service, or the builder output & asset dB 1109. Voice content components are also subjected to age-appropriate curation.

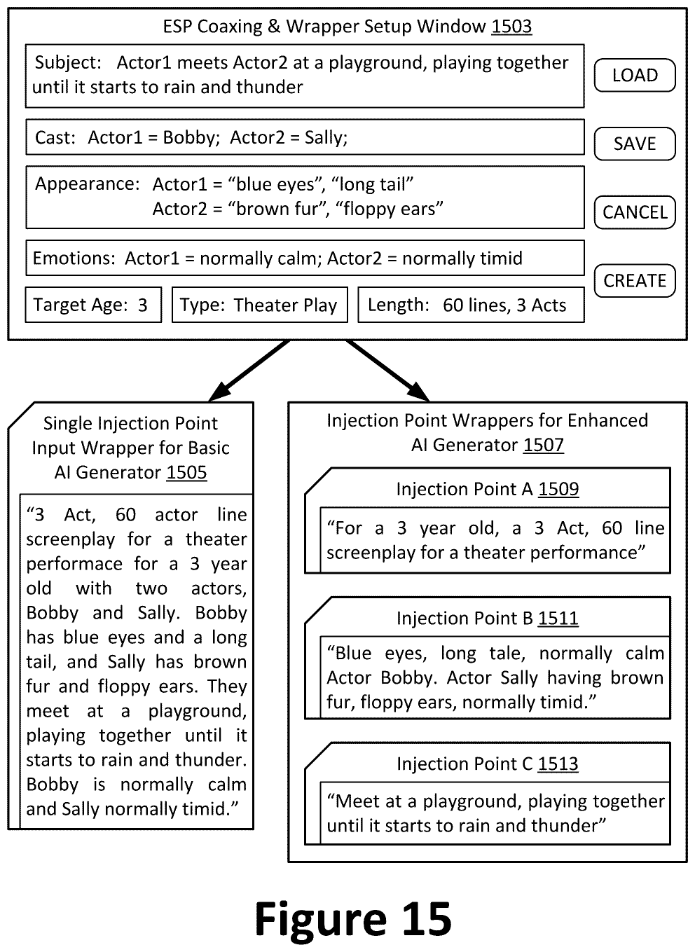

FIG. 15 depicts an exemplary user interaction window of the ESP Editor of FIG. 11 wherein an ESP Coaxing & Wrapper setup window 1503 facilitates specification or modification of a subject such as a skeleton of a storyline or a brief description of a required output, a cast(s) of actors, an appearance information provided as description of the actors, emotional states of the actors, a target age for consumers of the generated output, the type of output such as a theatre play, and the length of the output in lines and acts. These inputs setup can be saved for subsequent use or for subsequent modifications. FIG. 15 also depicts injection point wrappers for enhanced AI generator 1507 that specifies separate wrappers for multiple injection points, and a single injection point input wrapper for a basic AI generator 1505 wherein a single wrapper incorporates not only user request but also other constraints and parameters that are provided as input to a single injection point.

The various constrains or inputs provided in the window 1503 may be used at different injection points of an genAI service or model, such as a transformer, that has more than one place where it accepts inputs such as a query and constraints. Instead, these multiple pieces of information from the window 1503 that would normally fall within a single query for a typical single injection point AI server such as chatGPT, now gets split up into multiple injection pieces. However, not all injection pieces need to be treated with equal force or emphasis. So injection point emphasis can be included or specified, and, furthermore, even the preprocessing associated with each injection point can be different. For example, a typical user query takes the form of grammatical text. For some injection point's, data need not be in textual form. It may just be a list of constraints or guidance that will only suffer by being subjected to preprocessing typically applied to grammatical text and therefore need to be pre-processed differently. Thus, in multi-injection point pathways, at least for most situations, one injection point is provided for a user query or input that will then be subjected to typical preprocessing before injection into, for example, the encoder. In such multi-injection point pathways, each of the injection points have their own peculiar and fitted preprocessing. Atop that, weighting of inputs is applied, as one can easily imagine that some of the injection point flows are not as important as others. Mixing multiple injection inputs together into a single combined input to a single injection point, as shown in 1505, will likely result in loss of focus. However, for basic AI generators that provide a single injection point, the window 1505 depicts an exemplary single injection point input wrapper.

For configurations where multiple injection points are supported, such as in enhanced AI generators, window 1507 depicts an exemplary multiple injection point wrappers. Specifically, it displays different wrappers each for an injection point A 1509, an injection point B 1511 and for an injection point C 1513. Injection point A 1509 is assigned background constraints such as age of user (child 3 years old), number of acts of output (3 acts), and number of lines of a screenplay anticipated (60 lines). Injection point B 1511 is provided attributes of actors such as blue eyes, normally calm demeanor etc. Injection point C 1513 is provided with a context for character interactions, such as a “playground, playing together until it starts to rain and thunder”.

In addition to providing wrappers for multiple injection points, the present invention describes the concept of coaxing. Coaxing is appropriate and helpful when an SDK for an AI offering, for example, allows for supplement information and constraints thereto to be applied. All coaxing can be understood to be side saddle to the user query or input.

Thus, when we have wrappers, they typically do not include just the user query or input, but instead provide additional guidance and constraints that are placed on the AI generator when responding to the user query or input. A wrapper can then be a compilation of all guidance and constraints along with the actual user input/query—i.e., the constraints and guidance can be wrapped around the user input/query.

Wrappers of guidance and constraints have to be used if coaxing input pathways are not provided for same via an SDK. It is likely that some guidance/constraints will take the form of wrappers and others via coaxing inputs provided. In cases where you use multiple injection points, a coaxing input may be delivered via a dedicated injection point, while other coaxing inputs provided are delivered to additional injection points. And beyond that, wrappers will be needed to service particular guidance/constraints that is not anticipated or supported by the AI SDK. And, lastly, the preprocessing (the processing before reaching for example a decoder injection point which may include a modified encoder pathway), can be tailored specifically to service each type of coaxing input. These wrappers can be saved if necessary, and some of them can be saved as default.

The type constraint is shown as “theater play” in the exemplary data in window 1503, and the other constraints displayed may be those that are relevant to that type of content. If the type selected is changed to “jokes” or “story narration”, the length parameter and the emotions fields are likely to change accordingly.

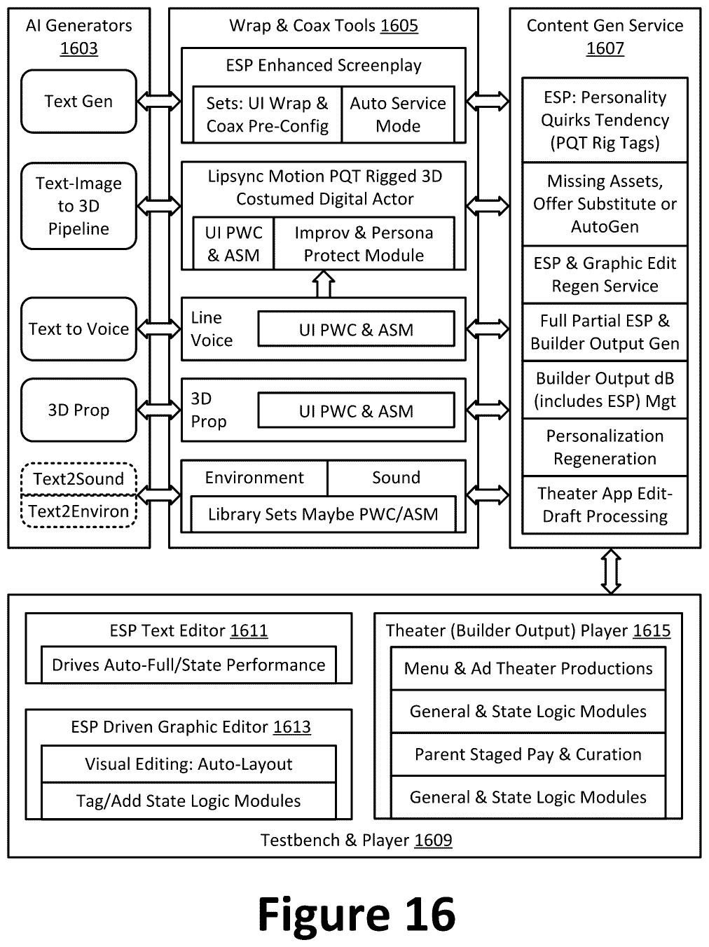

FIG. 16 is a functional block diagram of a further embodiment of the present invention wherein a theater performance is produced in an automatic approach with opportunities for editing. A mere request for a certain performance type and genre based on brief description user input will yield a full digital theater performance, including digital actors, voices, props, costumes and backdrop being automatically generated or automatically selected without further user involvement. The theater performance, digital in nature, taking place on cinema projection systems, personal computers and mobile devices.

The major blocks of the system include AI (Artificial Intelligence) generators 1603, wrap & coax tools 1605, content generation service 1607, and testbench & player 1609. The AI Generators 1603 comprises several subsystems responsible for automatically generating different types of content. These include AIs such as those that respond to minimal input text to generated enhanced screenplay (ESP) output which defines the theater performance to automatically be performed.

Other AI generators 1603 respond to text and/or image input to automatically generate motion and lipsynch rigged 3D actor models and 3D props, ready for deployment in the performance defined by the ESP. For lipsynch rigging of a 3D actor model and actor line speech, voice files from ESP text to voice AI generation takes place, again automatically in preparation for the theater performance. Additionally, if available and commissioned, some of the AI generators 1603, automatically produce backdrops (or scene environments) where the 3D actors will be carrying out certain scenes and theater acts. there is a Text2Sound module for generating sound from text and a Text2Environ module for creating environmental elements from textual descriptions. If unavailable and such backdrops cannot be created on the fly, they can be pre-created and stored in a library from which the ESP generation can choose as being most appropriate for each particular theater scene. Sounds, such as music, singing and sound effects (SFX), can either be automatically generated or be selected from library storage by the ESP generator.

The wrap and coax tools 1605 offer both an internal interface through which wrapper and coaxing text and settings can be created, tested and stored away to service particular types of functionality that the AI generators 1603 carry out. With wrappers and coaxing, the AI generators 1603 typically fail to deliver adequate output from which automatic theater productions can be based. Once wrapping and coaxing text and settings are established through the internal human interface (i.e., preconfigured), it can be saved away with other preconfigurations. From these preconfigurations based on a user or customer's request and personal parameters such as age, a preconfiguration of wrapper and coaxing data can be auto selected, loaded and used with corresponding ones of the AI generators 1603 to service an automatic theater production.

The wrap and coax tools 1605 therefor operate via a human visual interface for creating and saving the preconfigurations. Then, thereafter, operate through an application program interface (API) to service generation requests without needing any human interface. Specifically, such API requests flow from the content generation service. Whenever a need arises, the content generation service 1607 selectively communicates to trigger via the wrap and coax tools 1605 only those AI generators 1603 that are needed to carry out the automatic Theater presentation process.

When a theater player 1615, a 3D animation engine, selects a specific builder output for playback, the theater player 1615 looks to local storage to find all of the needed elements as identified in the ESP of the builder output along with all visual and audio assets required from a local database. If anything is missing, the theater player makes a request to the content generation service 1607 for such missing items. The content generation service 1607 first looks to the master database. If available there, the missing items are sent back to the theater player 1615 and the theater player 1615 begins a full playback-the full theater production. If unavailable from the master database, to procure the missing items, the content generator service 1607, if payment is or has already been made or earned (in game digital currency spending), will drive only the needed AI generators 1603 via the wrap and coax tools 1605.

Similarly, via any subblock of the testbench and player 1609, an entirely new theater production can be requested. Such a request flows through an API interface of the content generation service 1609 which first requests an ESP generation using the API interface to the wrap and coax tools 1605 which applies wrappers and coaxing to the original request from the testbench and player 1609. If in a purely automatic mode, the content generator service 1607 also launches requests for all other generation needed to carry out the newly generated ESP if such elements and items are not currently stored in the master database. If in a staged mode, the newly generated ESP is delivered for presentation in the ESP text editor 1611 where changes, rejection or acceptance can be made before wasting processing time and costs associated with the AI generators 1603.

If acceptable as is or with edits, the ESP text editor 1611 can then request that the content generator service 1607 complete the task, driving the AI generation of all of the missing items. Once all items needed are available, they are stored in the master database (cloud based) and locally in a database of the testbench and player 1609. From all of these generations, the 3D animation player, that is the theater player 1615, can deliver the full, new theater performance. As should be appreciated, a user of the testbench and player 1609 can request with very little words (voiced or direct text) a new theater production and be automatically presented with a response—a full theater production. For example, “tell me a bedtime story about a bicycle” or “teach me why it rains” or “can you tell me twenty jokes involving a frog” or “tell me how our country was formed.”

For each theater production, the content generator service 1607 includes (e.g., within JSON file structure that points to all associated theater production assets—herein “builder output”) the ESP (Enhanced Screenplay) which forms the basis for each theater production. The content generator service 1607 analyzes the ESP, identifying therefrom all the required assets including those that need coaxed and wrapped AI generation. And the ESP stored as part of the builder output is used in an interpretive state by state mode by the theater player 1615. That is, the theater player 1615 offers up selections of available theater productions and a user of the testbench and player 1609 may then choose one for playback and the underlying ESP acts as the animation state by state playback definition.

In some configurations, the theater player 1615 extracts position, motion and interaction information for use in automatically delivering the theater presentation. In other configurations, some of the extraction information is performed in advance by the content generation service 1607 to offload efforts on a user's computer running the testbench and player 1609. If extracted in advance, such extractions also become part of the builder output for that presentation.

3D actors are also automatically configured to speak their lines in a manner suitable for the underlying ESP. To that end, the wrap and coax tools 1605 work to drive the ESP generator of the AI generators 1603 to include very detailed instructions to our 3D actors. For example, when to smile and cry, when to yell or whisper and gesticulate or run or sit and so on. That is not all though. Like human actors, 3D actors can also carry personality, quirks and tendencies (herein PQT) that span beyond one theater performance. Many famous human stars can't escape this no matter what the lines happen to be or the director manages to coax out of them. This is a good thing that 3D actors according to the present invention can also carry. To do this, PQT characteristics are both programmed into their 3D models for physical face feature acting movements, but also each 3D actor carries with it a personality description that is added as coaxing and wrapping data when generating the ESP.

For example, when an ESP generated involving a 3D muscle man digital actor, it's PQT might include rigging for posing that happens at least once per Act while saying “what you are saying really pumps me up . . . see?”

PQT data can also have an accompanying AI which can refuse to take part in ESP's that stray outside of the 3D actor's PQT requirements. It can demand rewrites or turn down the opportunity to participate. This proves important when the 3D actor has a human counterpart acting star with PQT concerns regarding nudity, divisive issue side-taking and so on.

To this end, auto regeneration to accommodate one desired 3D actor's PQT will drive edits to the ESP from the 3D actor's PQT itself, all behind the scenes and automatically done such that a request by a user can be instantly serviced by a theater production without intermediate involvement. Further, the PQT characteristics can also be trained into a dedicated AI through which the 3D actor can perform self-curation of roles, usage, digital rights management, and even take on a fully improvisational style should an ESP allow it. This level of PQT can then unburden a real human actor from having to check every theater production that they are used in for payment concerns or for 3D acting behaviors and subject matter that, as a human, they are not comfortable with.

The content generator service 1607 can also respond to requests by a user on the testbench and player 1609 to personalize a theater production. Personalization can many forms such as switching out 3D actors to ones that the current user favors, generating new or alternate elements that the current user desires, or even changing names to that of family members (who themselves may have 3D actor counterparts).

Within the testbench and player 1609, in addition to the theater player 1615 and the ESP editor 1611, a graphic editor 1613 can be found. The graphic editor 1613 just like the ESP editor 1611 is not needed in the automatic process of generating a new theater production. All that takes is a minimal request and the theater player 1615 can begin 3D automation playback, delivering the theater presentation to the user.

Even so, should the user so desire, they can decide to make changes to the theater presentation via either the ESP editor 1611 or graphic editor 1613. As mentioned before, textual changes can be made to the ESP within the ESP editor 1611 and then update requests can be sent to the content generator service 1607 to carry out the changes made. Such changes can be textual or add props, change actors, add cues, and change or add state logic tags.

Similarly, visual changes can be made using the graphic editor 1613. The graphic editor 1613 provides what appears to be an enhanced theater player 1615 with play next state or play multiple states or play full commands. States are generally, actors lines based. When one actor speaks a line, that event along with associated motions and transitions (camera or otherwise) comprise a single state. States can begin or end with state logic applications as well. So the ESP defines all activities associated with a single state. These can be edited textually, but often that proves difficult when it involves graphic elements. For example, without evaluating the camera framing of a state or the positions of the actors, props and backdrop, a user cannot clearly identify the things they would like to change and see first-hand what such changes cause. This is how the graphic editor 1613 comes into play. For each state, a user can view the starting and ending state condition along with evaluating the movement and other things that happen in that state window. They can change these things too. All such changes are then reflected back into the ESP just as when ESP changes are reflected in the end to end production pathway to the theater player 1615.

That is, the graphic editor 1611 allows for dragging and dropping of 3D actors and props, including dropping new props into view or removing others. A user can change the camera FOV (field of view) and define camera transitions. Also, within the graphic editor 1611 editing in or out state logic functions is also possible. And, as with all editing herein, changes can be carried out via the content generation service 1607 such that a theater performance can be tuned to the satisfaction of the user.

For children, parents can be charged with curation to keep unwanted content generation from reaching the theater player 1615. This occurs in part through having the parent authorize micro-payments for each new production generation attempt. In addition, just like the PQT associated with each 3D actor, the ESP generation by the text generating AI of the AI generators 1603 can be wrapped and coaxed not to deliver ESPs that violate age and cultural appropriateness. So with a user's birth date required on installation, the testbench and player 1609 will both tailor theater presentations to be appropriate for such age range, and, then, by requiring a parent to verify the user's birthdate (the child's) during the payment process, which requires the parent's credit card setup along with parent's identification submission, a child will likely be prevented by the wrap and coax tools 1605 to be prevented from receiving an inappropriate ESP. Moreover, part of the parent's pay experience will involve reviewing the received ESP and, if inappropriate in their view, they can reject the payment or make whatever edits they would like before completing the transaction.

The theater player 1615 and associated theater productions are not just limited to entertaining or learning. Theater productions may themselves constitute menus wherein actors can offer various options for their currently available theater productions which do entertain. Selecting one will close the current theater production of menu purpose and open the selected theater production for animated playback. Similarly, theater products may be advertisements that can be inserted into an ongoing theater production.

And note that the theater player 1615 is not streaming video, although it could be configured to do so. Instead, it is a 3D animation player which is empty until it loads a backdrop scene environment, places the actors and props, and camera fades in to begin an on the fly animation playback defined by the ESP. Also note that the ending 3D condition of a prior state is the beginning 3D condition of the current state and so on, all according to ESP definition.

Examples of 3D animation engines behind the theater player 1615 include Unreal Engine™ and Unity3D™ product lines. Although the present embodiment involves 3D animation, 2D animation is also contemplated.

As mentioned, 3D actors may correspond to human actors or even a user, their family and pets. Backdrops and environments can be modeled after the user's home or living room. These options can also be automatically generated as directed via the content generation service 1607 which receives images, video and voice samples for delivery as coaxing and wrapping data for the wrap and coax tools 1605 to control their conversion to the digital 2D or 3D space for use in automatically generated theater productions thereafter.

Costume use is also defined within the ESP and can be autogenerated or selected from those costumes currently available according to ESP identified selections or indicated needs for AI generations. Sounds and special effects can be similarly called for in ESPs to be used from available database storage or via wrapped and coaxed auto generation.

The ESP thus contains not only typical screenplay content, but is enhanced to include commands for carrying out the automatic generation of the entire theater presentation. To accomplish this, additional guidance and coaxing text and settings are pre-configured into the wrap and coax tools 1605. In this way, once pre-configured, wrap and coax settings are reused to automatically service new theater performances. Each submodule of the wrap and coax tools 1605 are directed to enhance and guide production for certain target age customers/users, certain types of theater productions (like standup or sidekick comedy, teaching, narrative storytelling, acting pieces, advertising, menu systems, and so on), particular genres or styles, etc.

Thus, for example, a user/customer asking textually or verbally, “teach me about nuclear decay” then triggers an appropriate enhanced screenplay (ESP), all the underlying 3D elements, arranges the digital stage and directs the camera and actions—all automatically and without requiring user interaction beyond making the original request. This requires locating stage resources, and, where absent, automatically selecting appropriate wrapper and coaxing pre-configurations to drive AI generation of the absent resources. Once all resources identified in the ESP are generated or located, the presentation is ready to take place in a Theater Player window, which may be a projector and screen projection, personal computer screen or on any mobile device. The entire process happens automatically. Even so, the ESP text and visual placements and other visual aspects can be edited as will be appreciated as set forth below.

The content generation service 1607 responds to generation requests. Some requests require full regeneration while others request staged and partial regenerations to deal with user editing. is responsible for generating and managing content with a focus on personalization and enhancement. It includes features like ESP: Personality Quirks Tendency (PQT Rig Tags) to add unique personality traits to characters, tools for handling missing assets by offering substitutes or autogenerating content, and the ESP & Graphic Edit Regen Service for regenerating graphics and enhanced screenplays. The module also manages Builder Output dB, which includes ESP Management, Personalization Regeneration, and Theater App Edit-Draft Processing for refining theater app outputs.

The bottom section, Testbench & Player 1609, details specific editors and players that interact with the previously mentioned modules. The ESP Text Editor 1611 drives automated full/state performance and integrates with the ESP Driven Graphic Editor 1613 for visual editing with features like auto-layout and state logic modules. The Theater (Builder Output) Player 1615 includes components for managing menu and ad theater productions, general and state logic modules, parent staged pay and curation, and other theater production aspects.

Another enhancement, mentioned above, involves state logic tags (placed in the ESP via the wrapping and coaxing) which trigger programmatic behaviors associated with the theater player 1615. That is, the theater player 1615 respond in each state to carry out the functionality associated with a list of available state logic modules such as, branching within the current ESP, branching to another ESP, branching to display a hyperlink (via a browser window), gathering user input, and so on. All such modules can enhance a theater production being delivered by the theater player 1615 to make the event more interactive or otherwise delivering programmed effects to enhance the presentation. Through coaxing and wrapping by the wrap and coax tools 1605, the ESP automatically select and insert tags at reasonable locations so that even more complex theater presentations can be automatically generated and played back.

Other aspects of the present invention can be found in configurations of an artificial intelligence infrastructure having circuitry configured to gather at least one user's creation. The circuitry also being configured to automatically generate an overall artificial intelligence based topology based on the at least one user's creation gathered. In another configuration of the artificial intelligence infrastructure, circuitry is configured to gather a creation of a user, the creation serving an overall objective. Such circuitry also configured to automatically identify a plurality of frames from the creation of the user, wherein the plurality of frames being serviced by a corresponding plurality of topologies to accomplish, using artificial intelligence, the overall objective.

Further aspects of the present invention may be found in an artificial intelligence infrastructure having circuitry configured to gather a creation of a user, the creation serving an overall objective, where the circuitry automatically creates a plurality of frame topologies to serve, using artificial intelligence, the overall objective. Yet other aspects can be found in an artificial intelligence infrastructure supporting a user, having first and second circuitry. The first circuitry receives first source data and a user's work product created to service a first purpose, wherein the first source data being utilized by the user in the creation of at least a portion of the user's work product. The second circuitry generates at least one topology to be used in servicing the first purpose using artificial intelligence.

In another configuration of the artificial intelligence infrastructure, yet other aspects may be found. Therein, first circuitry receives first source data information and a human's work product created to service a first purpose, the first source data information being utilized in the creation of at least a portion of the human's work product. Second circuitry is provided which identifies using artificial intelligence at least one portion of the human's work product for future servicing by an artificial intelligence node.

A further embodiment of an artificial intelligence infrastructure illustrates yet other aspects of the present invention with first and second circuitry therein. The first circuitry receives a work product and first source data information used by a human to create the work product to service a first purpose, while the second circuitry configured to identify pattern data associated with at least one portion of the work product, the pattern data being used in future artificial intelligence based servicing of the first purpose.

Within another configuration of an artificial intelligence infrastructure, first and second circuitry operate to illustrate other aspects of the present invention. Specifically, for example, the first circuitry receives a first work product and first source data used by a human to create the work product to service a first purpose. The first circuitry also being configured to identify a plurality of frames based at least in part on the first work product. From the first work product, the second circuitry identifies cross frame influence between at least two of the plurality of frames.

Yet other aspects may be found in an artificial intelligence hosting infrastructure comprising circuitry that generates from a user's work product at least a portion of an artificial intelligence based topology to service a user's overall goal associated with the user's work product, wherein the circuitry also carries out hosting operations of the artificial intelligence based topology to service the user's overall goal.

In another configuration, within an artificial intelligence hosting infrastructure circuitry can be found which generates from a user's work product and underlying source data information at least a portion of an artificial intelligence based topology. The circuitry configured to host operations of the artificial intelligence based topology to carry out artificial intelligence generation in a form that corresponds to that of the user's work product.

Further aspects of the present invention can be found in yet another configuration of an artificial intelligence hosting infrastructure. Therein, circuitry identifies a plurality of elements within a user's overall work product. The plurality of elements are serviced by a corresponding plurality of generative artificial intelligence nodes. The circuitry also hosts artificial intelligence based operations using the plurality of generative artificial intelligence nodes to carry out an overall artificial intelligence based generation in a form that corresponds to that of the user's work product.

Yet other aspects may be found in an artificial intelligence infrastructure configuration with a circuitry that automatically generates from a user's work product at least a portion of an artificial intelligence based topology to service a user's overall goal associated with the user's work product. The circuitry also respond to user interaction relating to operations carried out based on the artificial intelligence based topology by modifying at least one aspect of the artificial intelligence based topology.

Further aspects can be found in circuitry of artificial intelligence infrastructure that automatically generates from a user's work product at least a portion of an artificial intelligence based topology to service a user's overall goal associated with the user's work product. Such circuitry responds to user input by regenerating at least a portion of operations carried out in accordance with the artificial intelligence based topology.

Yet various other aspects of the present can be found in an artificial intelligence infrastructure that supports a user. Therein, circuitry automatically generates, from a work product of the user and from underlying source data information, at least a portion of an artificial intelligence based topology to service an overall goal of the user, the overall goal being serviced by the work product. The circuitry also extracts the underlying source data information by monitoring interactions of the user that the user employed when creating the work product.

In addition, although throughout this specification selected exemplary embodiments have been used to illustrate particular aspects of the present invention, all of these aspects are contemplated as being combinable into a single embodiment or extracted into any subset of such aspects into enumerable other embodiments. Thus, the boundaries of each embodiment regarding particular aspects included therein are merely for illustrating operation of a select group of aspects and are in no way considered to limit the overall breadth of such aspects or the ability of combining them as so desired and as one of ordinary skill in the art can surely contemplate after receiving the teachings herein.

The terms “circuit” and “circuitry” as used herein may refer to an independent circuit or to a portion of a multifunctional circuit that performs multiple underlying functions. For example, depending on the embodiment, processing circuitry may be implemented as a single chip processor or as a plurality of processing chips. It may also include neural network circuit elements, accelerators supporting software AI models. Likewise, a first circuit and a second circuit may be combined in one embodiment into a single circuit or, in another embodiment, operate independently perhaps in separate chips. The term “chip,” as used herein, refers to an integrated circuit. Circuits and circuitry may comprise general or specific purpose hardware, or may comprise such hardware and associated software such as firmware or object code.

The term “AI models” refers to a software defined neural network infrastructure that operates on processing circuitry and may use accelerator circuitry to carry out its underlying functionality. Any AI element may also be constructed in whole or in part in hardware via analog and/or digital circuits that play a major part in carrying out AI related functionality. As used herein, the term “AI node” may comprise a purely software AI model or an accelerated AI model. It may also comprise one or more neural network circuits and associated support processing.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module may or may not modify the information of a signal and may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

The present invention has also been described above with the aid of method steps illustrating the performance of specified functions and relationships thereof. The boundaries and sequence of these functional building blocks and method steps have been arbitrarily defined herein for convenience of description, and can be apportioned and ordered in different ways in other embodiments within the scope of the teachings herein. Alternate boundaries and sequences can be defined so long as certain specified functions and relationships are appropriately performed/present. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block/step boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof. Although the Internet is taught herein, the Internet may be configured in one of many different manners, may contain many different types of equipment in different configurations, and may be replaced or augmented with any network or communication protocol of any kind.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A neural processing unit, the neural processing unit comprising:
a plurality of influence data, a first of the plurality of influence data having received a first preprocessing, and a second of the plurality of influence data having received a second preprocessing, the second preprocessing differing from the first preprocessing; and
at least a portion of the neural processing unit, having a plurality of injection points corresponding to the plurality of influence data, that is operational to deliver a generated output based on the plurality of influence data.

2. A neural processing unit, the neural processing unit comprising:
a plurality of influence data, a first of the plurality of influence data having received a first preprocessing, a second of the plurality of influence data having received a second preprocessing, the second preprocessing differing from the first preprocessing, and the first of the plurality of influence data being query data; and
at least a portion of the neural processing unit being operational to deliver a generated output based on the plurality of influence data.

3. (canceled)

4. A neural processing architecture, the neural processing architecture comprising:
a first generator portion located at a remote location having a first injection point;
a second generator portion located locally having a second injection point; and
a plurality of influence data, a first of the plurality of influence data having received a first preprocessing, a second of the plurality of influence data having received a second preprocessing, the first of the plurality of influence data being configured for delivery to the first injection point, the second of the plurality of influence data being configured for deliver to the second injection point.

5. (canceled)
